(19) United States
(12) Patent Application Publication
(10) Pub. No.: US 2025/0042766 A1
(43) Pub. Date: Feb. 6, 2025

(54) CATHODE ACTIVE MATERIALS AND THEIR PREPARATION METHODS

(71) Applicant: Industry-University Cooperation Foundation Hanyang University Erica Campus, Ansan-si (KR)

(72) Inventors: Jin Ho Bang, Ansan-si (KR); Woo Won CHUNG, Ansan-si (KR)

(21) Appl. No.: 18/906,187

(22) Filed: Oct. 4, 2024

Related U.S. Application Data
(63) Continuation of application No. PCT/KR2023/004547, filed on Apr. 5, 2023.

(30) Foreign Application Priority Data
Apr. 6, 2022 (KR) 10-2022-0042978
Mar. 14, 2023 (KR) 10-2023-0033088

(51) Int. Cl. C01G 53/00; H01M 4/525

(52) U.S. Cl. CPC C01G 53/42; H01M 4/525; C01P 2002/50; C01P 2002/72; C01P 2002/85; C01P 2002/88; C01P 2004/03; C01P 2004/50; C01P 2004/61; C01P 2004/62; C01P 2006/40

(57) ABSTRACT

The method for manufacturing a positive electrode active material according to the present invention comprises the steps of: constructing positive electrode active material precursor particles containing nickel; preparing a lithium source; and mixing the positive electrode active material precursor particles and the lithium source, followed by heat-treatment to produce a positive electrode active material in which a plurality of primary particles are agglomerated, wherein the generation rate of the primary particles of the positive electrode active material is controlled by controlling the sizes of the positive electrode active material precursor particles during the heat-treatment step.

### TECHNICAL FIELD

The present invention relates to a positive electrode active material and a method for manufacturing the same, and more particularly, to a positive electrode active material and a method for manufacturing the same to include controlling a precursor particle size of a positive electrode active material to control a size of the positive electrode active material, and a method for manufacturing the same.

### BACKGROUND ART

The positive electrode active material refers to an active material that is present in a positive electrode material of a secondary battery and electrochemically generates electrical energy.

The positive electrode active material present in the positive electrode material has lithium ions in an initial state and serves to provide lithium ions to the anode during charging of the secondary battery.

Accordingly, positive electrode active materials are used in various industries such as lithium metal batteries, lithium air batteries, and lithium ion polymer batteries.

As the application field increases, various positive electrode active materials have been studied. For example, Korean Patent Registration Publication No. 10-0815583 discloses a method for preparing a positive electrode active material for a lithium secondary battery, which includes the steps of: mixing a metal salt aqueous solution, which contains a first metal including nickel, cobalt and manganese, and optionally a second metal, a chelating agent, and a basic aqueous solution to prepare a co-precipitation compound; preparing an active material precursor by drying or heat-treating the co-precipitation compound; and preparing a lithium composite metal oxide by mixing and sintering the active material precursor and a lithium salt, wherein the lithium composite metal oxide has a layered structure.

### DISCLOSURE

### Technical Problem

One technical problem to be solved by the present invention is to provide a method for preparing a positive electrode active material having improved rate-limiting characteristics.

Another technical problem to be solved by the present invention is to provide a method for preparing a positive electrode active material having improved stability with respect to a charging/discharging cycle.

Still another technical problem to be solved by the present invention is to provide a method for preparing a positive electrode active material at a low preparing process cost.

Still another technical problem to be solved by the present invention is to provide a method for preparing a positive electrode active material with a shortened preparing time.

Still another technical problem to be solved by the present invention is to provide a method for preparing a positive electrode active material to be easily mass produced.

The technical problem to be solved by the present invention is not limited to the above-described technical problems.

### Technical Solution

In order to solve the above technical problems, the present invention provides a method for preparing a positive electrode active material.

According to one embodiment, the method for preparing a positive electrode active material may include preparing positive electrode active material precursor particles including nickel, preparing a lithium source, and mixing and heat-treating the positive electrode active material precursor particles and the lithium source to prepare a positive electrode active material in which a plurality of primary particles are aggregated, and the heat-treating may include controlling a generation rate of the primary particles of the positive electrode active material by controlling sizes of the positive electrode active material precursor particles.

According to the one embodiment, when the positive electrode active material precursor particles have smaller sizes, the generation rate of the primary particles of the positive electrode active material may be faster.

According to the one embodiment, when the positive electrode active material precursor particles have smaller sizes, uniformity of the sizes of the primary particles of the positive electrode active material may decrease, and density of a center of the positive electrode active material may decrease.

According to the one embodiment, the positive electrode active material precursor particle may have the size equal or greater than 4 um and equal or less than 16 um.

According to the one embodiment, the heat-treating of the positive electrode active material precursor particles and the lithium source may include controlling an oxygen partial pressure to be greater than 0.3 L/min and less than 1.0 L/min, wherein the positive electrode active material may have a I₀₀₃/I₁₀₄ ratio greater than 1.74.

According to the one embodiment, the heat-treating of the positive electrode active material precursor particles and the lithium source may include mixing nickel of the positive electrode active material precursor particles and lithium of the lithium source to have a molar ratio greater than 1:1.01 and less than 1:1.05, wherein the positive electrode active material may have a I₀₀₃/I₁₀₄ ratio greater than 1.74.

According to the one embodiment, the preparing of the positive electrode active material precursor particles may include preparing for a precursor source including nickel, a reducing agent and a pH adjusting agent, and providing and co-precipitating the precursor source, the reducing agent and the pH adjusting agent to a reactor, so as to prepare the positive electrode active material precursor particles.

According to the one embodiment, the preparing of the positive electrode active material precursor particles may include controlling the size of the positive electrode active material precursor particles by controlling a stirring speed of mixing the precursor source, the reducing agent and the pH adjusting agent.

According to the one embodiment, the method for preparing a positive electrode active material may include preparing positive electrode active material precursor particles including nickel; preparing for a lithium source; and mixing and heat-treating the positive electrode active material precursor particles and the lithium source to prepare the positive electrode active material in which a plurality of primary particles are aggregated, and may further include controlling a mixing level of cations of the nickel and cations of the lithium in the positive electrode active material by controlling sizes of the positive electrode active material precursor particles.

According to the one embodiment, when the positive electrode active material precursor particles have decreased sizes, the mixing level of the cation of the nickel and the cation of the lithium in the positive electrode active material may increase.

According to the one embodiment, a grain size of the positive electrode active material may be controlled by controlling the sizes of the positive electrode active material precursor particles.

According to the one embodiment, when the positive electrode active material precursor particles have smaller sizes, the grain size of the positive electrode active material may be greater.

In order to solve the above technical problems, the present invention provides a positive electrode active material prepared by the above-described method for preparing the positive electrode active material.

According to the one embodiment, In the positive electrode active material including secondary particles formed by aggregating the primary particles, I₀₀₃/I₀₀₄, which is a ratio of a peak value I₀₀₃ corresponding to a (003) plane to a peak value I₁₀₄ corresponding to a (104) plane, may exceed 1.74 when XRD measurement is performed on the positive electrode active material.

According to the one embodiment, the positive electrode active material may have particle sizes equal or greater than 4 um and equal or less than 16 um.

According to the one embodiment, the positive electrode active material may have a composition of <Formula> below.

LiNiO₂ <Formula>

According to the one embodiment, the positive electrode active material may have a grain size greater than 105.0 nm and less than 158.2 nm.

### Advantageous Effects

The method for preparing a positive electrode active material according to the present invention may include providing and co-precipitating a precursor source, a reducing agent and a pH adjusting agent to a reactor, and mixing and heat-treating positive electrode active material precursor particles and a lithium source.

Accordingly, in the step of providing and co-precipitating the precursor source, the reducing agent and the pH adjusting agent to the reactor, the sizes of the positive electrode active material precursor particles may be controlled by controlling the stirring speed, the stirring time, and the pH of mixing the precursor source, the reducing agent and the pH adjusting agent.

In addition, in the step of mixing and heat-treating the positive electrode active material precursor particles and the lithium source, the sizes of the positive electrode active material precursor particles may be controlled to control the size uniformity and generation rate of the primary particles of the positive electrode active material, and the grain size, core density, and mixing level of the positive electrode active material. In addition, the crystal structure of the positive electrode active material precursor particle may be controlled by controlling the oxygen partial pressure and the molar ratio of the lithium source.

Accordingly, in the prepared positive electrode active material of the present invention, I₀₀₃/I₁₀₄ may exceed 1.74 (reference I₀₀₃/I₁₀₄). Therefore, the positive electrode active material may have a stable crystal structure because Layered Structure Phase is increased more than the reference I₀₀₃/I₁₀₄. Accordingly, when the positive electrode active material is applied to a lithium secondary battery, lithium ions may be easily deintercalated/intercalated due to the stable crystal structure of the positive electrode active material. As a result, the rate-limiting characteristics of the lithium secondary battery and the stability of the charging/discharging cycle may be improved.

### DESCRIPTION OF DRAWINGS

FIG. 1 is a flowchart explaining a method for preparing a positive electrode active material according to the one embodiment of the present invention.

FIG. 2 is a flowchart explaining a method for preparing a positive electrode active material precursor particle according to the one embodiment of the present invention.

FIG. 3 is a view for explaining a precursor source, a reducing agent and a pH adjusting agent according to the one embodiment of the present invention.

FIG. 4 is a view for explaining a method for preparing a positive electrode active material precursor particle by providing and co-precipitating a precursor source, a reducing agent and a pH adjusting agent to a reactor according to the one embodiment of the present invention.

FIG. 5 is a view for explaining a method for heat-treating a positive electrode active material precursor particle and a lithium source to prepare a positive electrode active material.

FIG. 6 is a view for explaining a positive electrode active material and primary particles of the positive electrode active material.

FIG. 7A is a graph obtained by XRD-analyzing a process of heat-treating positive electrode active material precursor particles and a lithium source according to Experimental Example 1 of the present invention.

FIG. 7B is a graph obtained by XRD-analyzing a process of heat-treating positive electrode active material precursor particles and a lithium source according to Experimental Example 2 of the present invention.

FIG. 7C is a graph obtained by XRD-analyzing a process of heat-treating positive electrode active material precursor particles and a lithium source according to Experimental Example 3 of the present invention.

FIG. 7D is a graph obtained by XRD-analyzing a process of heat-treating positive electrode active material precursor particles and a lithium source according to Experimental Example 4 of the present invention.

FIG. 7E is a graph obtained by analyzing, through differential scanning calorimetry (DSC), a process of heat-treating positive electrode active material precursor particles and a lithium source according to Experimental Examples 1 to 4 of the present invention.

FIG. 8A is a sectional SEM photograph of a positive electrode active material according to Experimental Example 1 of the present invention and a graph showing a sectional area distribution of primary particles of the positive electrode active material.

FIG. 8B is a sectional SEM photograph of a positive electrode active material according to Experimental Example 2 of the present invention and a graph showing a sectional area distribution of primary particles of the positive electrode active material.

FIG. 8C is a sectional SEM photograph of a positive electrode active material according to Experimental Example 3 of the present invention and a graph showing a sectional area distribution of primary particles of the positive electrode active material.

FIG. 8D is a sectional SEM photograph of a positive electrode active material according to Experimental Example 4 of the present invention and a graph showing a sectional area distribution of primary particles of the positive electrode active material.

FIG. 9A is an SEM photograph of a positive electrode active material according to Experimental Example 1 of the present invention.

FIG. 9B is an SEM photograph of a positive electrode active material according to Experimental Example 2 of the present invention.

FIG. 9C is an SEM photograph of a positive electrode active material according to Experimental Example 3 of the present invention.

FIG. 9D is an SEM photograph of a positive electrode active material according to Experimental Example 4 of the present invention.

FIG. 10A shows graphs resulted from XRD analysis on positive electrode active materials according to Experimental Examples 1 to 4 of the present invention.

FIG. 10B is a graph obtained by performing XRD analysis and Rietveld Refinement on a positive electrode active material according to Experimental Example 1 of the present invention.

FIG. 10C is a graph obtained by performing XRD analysis and Rietveld Refinement on a positive electrode active material according to Experimental Example 2 of the present invention.

FIG. 10D is a graph obtained by performing XRD analysis and Rietveld Refinement on a positive electrode active material according to Experimental Example 3 of the present invention.

FIG. 10E is a graph obtained by performing XRD analysis and Rietveld Refinement on a positive electrode active material according to Experimental Example 4 of the present invention.

FIG. 11 shows graphs of XPS analysis of the positive electrode active materials according to Experimental Examples 1 to 4 of the present invention.

FIG. 12A is a graph for comparing rate-limiting characteristics of Full Cells to which the positive electrode active materials according to Experimental Examples 1 to 4 of the present invention are applied.

FIG. 12B is a graph for comparing the specific capacity for each cycle of Half Cells to which the positive electrode active materials according to Experimental Examples 1 to 4 of the present invention are applied.

FIG. 12C is a graph for comparing the long-term stability of Full Cells to which the positive electrode active materials according to Experimental Examples 1 to 4 of the present invention are applied.

FIG. 13A is a graph for comparing R_{ct} values in initial states of Half Cells to which the positive electrode active materials according to Experimental Examples 1 to 4 of the present invention are applied.

FIG. 13B is a graph for comparing R_{ct} values after performing 100 cycles of charging/discharging of Half Cells to which the positive electrode active materials according to Experimental Examples 1 to 4 of the present invention are applied.

FIG. 14A shows graphs for comparing diffusion resistance of lithium ions in initial states of Half Cells to which the positive electrode active materials according to Experimental Examples 1 to 4 of the present invention are applied.

FIG. 14B shows graphs for comparing diffusion resistance of lithium ions in states after performing 100 cycles of charging/discharging of Half Cells to which the positive electrode active materials according to Experimental Examples 1 to 4 of the present invention are applied.

FIG. 15A shows an SEM photograph of a positive electrode active material generated under each of heat-treatment conditions of positive electrode active material precursor particles and a lithium source according to Experimental Example 1 of the present invention.

FIG. 15B shows an SEM photograph of a positive electrode active material generated under each of heat-treatment conditions of positive electrode active material precursor particles and a lithium source according to Experimental Example 2 of the present invention.

FIG. 15C shows an SEM photograph of a positive electrode active material generated under each of heat-treatment conditions of positive electrode active material precursor particles and a lithium source according to Experimental Example 3 of the present invention.

FIG. 15D shows an SEM photograph of a positive electrode active material generated under each of heat-treatment conditions of positive electrode active material precursor particles and a lithium source according to Experimental Example 4 of the present invention.

FIG. 16A and FIG. 16B are graphs obtained by measuring porosity of positive electrode active material precursor particles according to Experimental Examples 1 to 4 of the present invention by BET.

FIG. 17 is an XPS graph for comparing oxygen vacancies of positive electrode active materials according to Experimental Examples 1 to 4 of the present invention.

FIG. 18A shows graphs for comparing a-axis change amounts of a crystal structure of a positive electrode active material during a charging process of Half Cells to which positive electrode active materials according to Experimental Examples 1 to 4 of the present invention are applied.

FIG. 18B shows graphs for comparing c-axis change amounts of a crystal structure of a positive electrode active material during a charging process of Half Cells to which the positive electrode active materials according to Experimental Examples 1 to 4 of the present invention are applied.

FIG. 18C shows graphs for comparing a-axis change amounts of a lattice structure of a positive electrode active material in a discharging process of Half Cells to which positive electrode active materials according to Experimental Examples 1 to 4 of the present invention are applied.

FIG. 18D shows graphs for comparing c-axis change amounts of a lattice structure of a positive electrode active material in a discharging process of Half Cells to which positive electrode active materials according to Experimental Examples 1 to 4 of the present invention are applied.

FIG. 19A is a sectional SEM photograph of a positive electrode active material after one cycle of charging/discharging of a Half Cell to which the positive electrode active material according to Experimental Example 1 of the present invention is applied.

FIG. 19B is a sectional SEM photograph of a positive electrode active material after one cycle of charging/discharging of a Half Cell to which the positive electrode active material according to Experimental Example 2 of the present invention is applied.

FIG. 19C is a sectional SEM photograph of a positive electrode active material after one cycle of charging/discharging of a Half Cell to which the positive electrode active material according to Experimental Example 3 of the present invention is applied.

FIG. 19D is a sectional SEM photograph of a positive electrode active material after one cycle of charging/discharging of a Half Cell to which the positive electrode active material according to Experimental Example 4 of the present invention is applied.

FIG. 20A is a sectional SEM photograph of a positive electrode active material after 100 cycles of charging/discharging of a Half Cell to which the positive electrode active material according to Experimental Example 1 of the present invention is applied.

FIG. 20B is a sectional SEM photograph of a positive electrode active material after 100 cycles of charging/discharging of a Half Cell to which the positive electrode active material according to Experimental Example 2 of the present invention is applied.

FIG. 20C is a sectional SEM photograph of a positive electrode active material after 100 cycles of charging/discharging of a Half Cell to which the positive electrode active material according to Experimental Example 3 of the present invention is applied.

FIG. 20D is a sectional SEM photograph of a positive electrode active material after 100 cycles of charging/discharging of a Half Cell to which the positive electrode active material according to Experimental Example 4 of the present invention is applied.

FIG. 21A is a graph of XRD analysis of a positive electrode active material prepared by controlling an oxygen flow rate in a process of heat-treating positive electrode active material precursor particles and a lithium source according to Experimental Example 3 of the present invention.

FIG. 21B is an SEM photograph of a positive electrode active material prepared by controlling an oxygen flow rate in a process of heat-treating positive electrode active material precursor particles and a lithium source according to Experimental Example 3 of the present invention.

FIG. 21C is a graph for comparing a ratio of (003)-plane and (104)-plane of a positive electrode active material prepared by controlling an oxygen flow rate in a process of heat-treating positive electrode active material precursor particles and a lithium source according to Experimental Example 3 of the present invention.

FIG. 21D is a graph for comparing the specific capacity for each cycle of a Half Cell to which a positive electrode active material prepared by controlling an oxygen flow rate in a process of heat-treating positive electrode active material precursor particles and a lithium source according to Experimental Example 3 of the present invention is applied.

FIG. 22A is a graph of XRD analysis of a positive electrode active material prepared by controlling a molar ratio of a lithium source in a process of heat-treating positive electrode active material precursor particles and the lithium source according to Experimental Example 3 of the present invention.

FIG. 22B is an SEM photograph of a positive electrode active material prepared by controlling a molar ratio of a lithium source in a process of heat-treating positive electrode active material precursor particles and the lithium source according to Experimental Example 3 of the present invention.

FIG. 22C is a graph for comparing the specific capacity for each cycle of a Half Cell to which a positive electrode active material prepared by controlling a molar ratio of a lithium source in a process of heat-treating positive electrode active material precursor particles and the lithium source according to Experimental Example 3 of the present invention is applied.

FIG. 22D is a graph showing the specific capacity measured when the molar ratio of lithium in the positive electrode active material particles is controlled according to Experimental Example 1 of the present invention.

FIGS. 23A to 23D are graphs for comparing, by TGA, changes in weight of positive electrode active material precursor particles and a lithium source according to heating rates in a process of heat-treating the positive electrode active material precursor particles and the lithium source according to Experimental Examples 1 to 4 of the present invention.

FIG. 23E is a graph showing activation energy for section I of FIGS. 23A to 23D.

FIG. 23F is a graph showing activation energy for section II of FIGS. 23A to 23D.

FIG. 24A is a photograph of positive electrode active material precursor particles according to Experimental Example 1 of the present invention.

FIG. 24B is a photograph of positive electrode active material precursor particles according to Experimental Example 2 of the present invention.

FIG. 24C is a photograph of positive electrode active material precursor particles according to Experimental Example 3 of the present invention.

FIG. 24D is a photograph of positive electrode active material precursor particles according to Experimental Example 4 of the present invention.

FIG. 25A is an SEM photograph after hand-mixing positive electrode active material precursor particles according to Experimental Example 3 of the present invention.

FIG. 25B is an SEM photograph after hand-mixing a lithium source according to Experimental Example 3 of the present invention.

FIG. 25C is an SEM photograph after mechanically mixing positive electrode active material precursor particles according to Experimental Example 3 of the present invention.

FIG. 25D is an SEM photograph after mechanically mixing a lithium source according to Experimental Example 3 of the present invention.

FIG. 26A shows an SEM photograph of positive electrode active material precursor particles according to Experimental Example 1 and a graph showing size distribution of the positive electrode active material precursor particles.

FIG. 26B shows an SEM photograph of positive electrode active material precursor particles according to Experimental Example 2 and a graph showing size distribution of the positive electrode active material precursor particles.

FIG. 26C shows an SEM photograph of positive electrode active material precursor particles according to Experimental Example 3 and a graph showing size distribution of the positive electrode active material precursor particles.

FIG. 26D shows an SEM photograph of positive electrode active material precursor particles according to Experimental Example 4 and a graph showing size distribution of the positive electrode active material precursor particles.

FIG. 27A is a sectional photograph of positive electrode active material precursor particles according to Experimental Example 1 of the present invention.

FIG. 27B is a sectional photograph of positive electrode active material precursor particles according to Experimental Example 2 of the present invention.

FIG. 27C is a sectional photograph of positive electrode active material precursor particles according to Experimental Example 3 of the present invention.

FIG. 27D is a sectional photograph of positive electrode active material precursor particles according to Experimental Example 4 of the present invention.

### BEST MODE

### Mode for Invention

Hereinafter, exemplary embodiments of the present invention will be described in detail with reference to the accompanying drawings. However, the technical idea of the present invention is not limited to the embodiments described herein and may be embodied in other forms. Rather, the embodiments introduced herein are provided such that the disclosed contents may be thorough and complete and the idea of the present invention may be sufficiently conveyed to those skilled in the art.

In this specification, when one component is referred to as being on other component, it signifies that the one component may be formed directly on the other component or a third component may be interposed therebetween. In addition, in the drawings, thicknesses of a film and a region are exaggerated for effective description of the technical contents.

In addition, the terms such as first, second, third, and the like are used in various embodiments of the present invention to describe various components, but these components will not be limited by the terms. These terms are only used to distinguish one component from another component. Accordingly, a component mentioned as the first component in one embodiment may be mentioned as the second component in another embodiment. Each embodiment described and exemplified herein includes a complementary embodiment thereof. In addition, the term “and/or” in the present specification is used as a meaning including at least one of the components listed previously and later.

In the specification, a singular expression includes a plural expression unless the context clearly indicates otherwise. In addition, terms such as “include” or “have” are intended to designate the presence of features, numbers, steps, components, or combinations thereof described in the specification, and will not be understood to preclude the possibility of the presence or addition of one or more other features, numbers, steps, components, or combinations thereof. In addition, the term “connection” in the present specification is used as a meaning including both indirectly connecting a plurality of components and directly connecting the components.

In addition, in the following description of the present invention, when it is determined that a detailed description of a related known function or configuration may unnecessarily obscure the subject matter of the present invention, the detailed description thereof will be omitted.

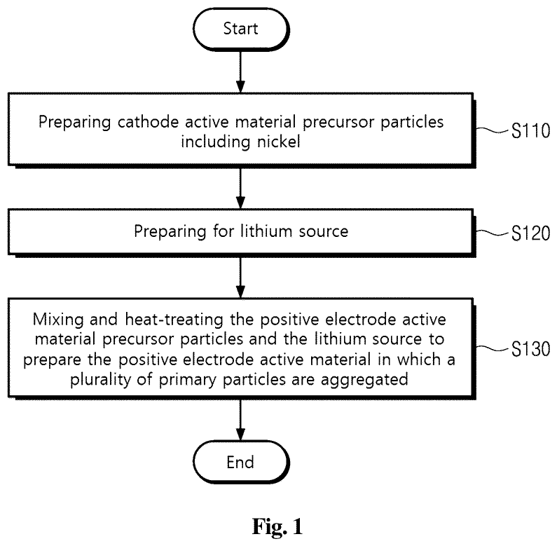

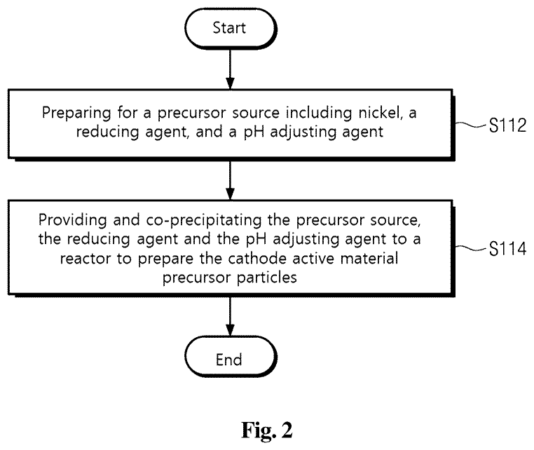

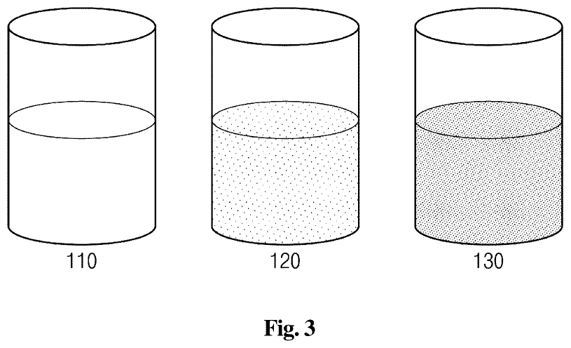

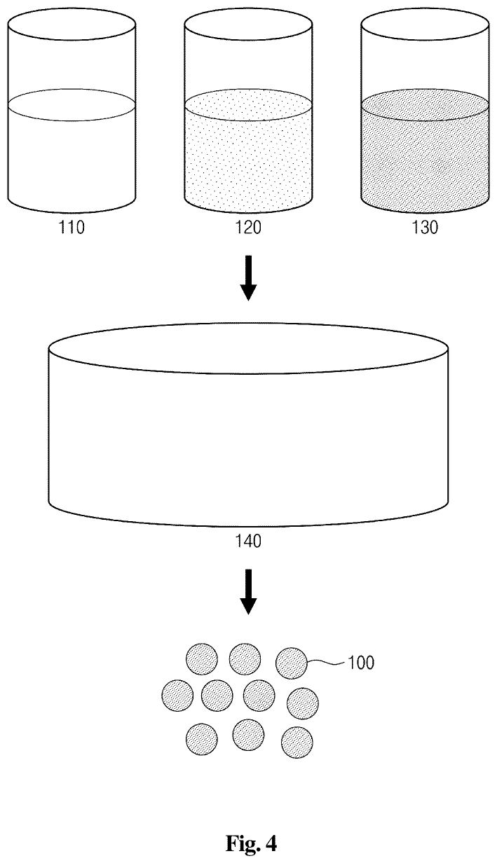

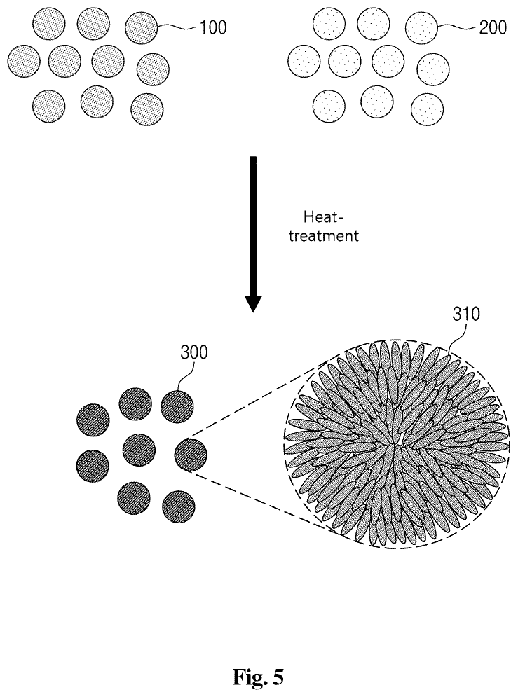

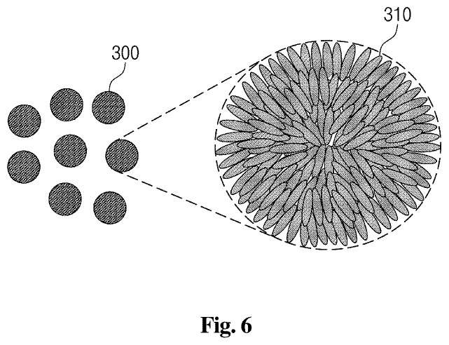

FIG. 1 is a flowchart for describing a method for preparing a positive electrode active material according to the one embodiment of the present invention; FIG. 2 is a flowchart for describing a method for preparing positive electrode active material precursor particles according to the one embodiment of the present invention; FIG. 3 is a view for describing a precursor source, a reducing agent and a pH adjusting agent according to the one embodiment of the present invention; FIG. 4 is a view for describing a method for preparing positive electrode active material precursor particles by providing and co-precipitating a precursor source, a reducing agent, and a pH adjusting agent to areactor according to the one embodiment of the present invention; FIG. 5 is a view for describing a method for preparing a positive electrode active material by heat-treating positive electrode active material precursor particles and a lithium source; and FIG. 6 is a view for describing a positive electrode active material and primary particles of the positive electrode active material.

Referring to FIGS. 1 to 4, positive electrode active material precursor particles 100 including nickel are prepared (S110).

The preparing of the positive electrode active material precursor particles 100 may include a step (S112) of preparing for a precursor source 110 including nickel, a reducing agent 120, and a pH adjusting agent 130, and a step (S140) of providing and co-precipitating the precursor source 110, the reducing agent 120, and the pH adjusting agent 130 to a reactor 140.

In the step (S112) of preparing for the precursor source 110, the reducing agent 120, and the pH adjusting agent 130, the precursor source 110 may be NiSO₄·6H₂O, for example. For example, the reducing agent 120 may be NH4OH. For example, the pH adjusting agent 130 may be NaOH.

In the step of providing and co-precipitating the precursor source 110, the reducing agent 120, and the pH adjusting agent 130 to the reactor 140, the stirring speed, the stirring time, and the pH of mixing the precursor source 110, the reducing agent 120, and the pH adjusting agent 130 may be controlled.

Sizes of the positive electrode active material precursor particles 100 may be controlled according to the stirring speed of mixing the precursor source 110, the reducing agent 120 and the pH adjusting agent 130. When the stirring speed of mixing the precursor source 110, the reducing agent 120, and the pH adjusting agent 130 increases, the sizes of the positive electrode active material precursor particles 100 may decrease. In contrast, when the stirring speed of mixing the reducing agent 120 and the pH adjusting agent 130 decreases, the sizes of the positive electrode active material precursor particles 100 may increase.

In addition, the sizes of the positive electrode active material precursor particles 100 may be controlled according to the stirring time for mixing the precursor source 110, the reducing agent 120, and the pH adjusting agent 130. When the stirring time for mixing the precursor source 110, the reducing agent 120, and the pH adjusting agent 130 decreases, the sizes of the positive electrode active material precursor particles 100 may decrease. In contrast, when the stirring time for mixing the reducing agent 120 and the pH adjusting agent 130 increases, the sizes of the positive electrode active material precursor particles 100 may increase. The sizes of the positive electrode active material precursor particles 100 may be controlled according to the pH of mixing the precursor source 110, the reducing agent 120, and the pH adjusting agent 130.

In addition, when the pH of mixing the precursor source 110, the reducing agent 120, and the pH adjusting agent 130 increases, the sizes of the positive electrode active material precursor particles 100 may decrease. In contrast, when the pH of mixing the reducing agent 120 and the pH adjusting agent 130 decreases, the sizes of the positive electrode active material precursor particle 100 may increase

In conclusion, in the step of providing and co-precipitating the precursor source 110, the reducing agent 120, and the pH adjusting agent 130 to the reactor 140, the sizes of the positive electrode active material precursor particles 100 may be controlled by controlling the stirring speed, the stirring time, and the pH of mixing the precursor source 110, the reducing agent 120, and the pH adjusting agent 130. As described below, the sizes of the positive electrode active material precursor particles 100 may be controlled to be equal or greater than 4 um and equal or less than 16 um. Or, alternatively, the sizes of the positive electrode active material precursor particles 100 may be controlled to be greater than 8 um and less than 16 um.

Referring to FIGS. 1 and 5, the positive electrode active material precursor particles 100 including nickel and a lithium source 200 are prepared (S120).

In the step of preparing for the positive electrode active material precursor particles 100 and the lithium source 200, the positive electrode active material precursor particles 100 may be Ni(OH)₂, for example. For example, the lithium source 200 may be LiOH·H2O.

As described below, the molar ratio of nickel of the positive electrode active material precursor particles 100 and lithium of the lithium source 200 may be controlled to be greater than 1:1.01 and less than 1:1.05.

Referring to FIGS. 1 and 5, the positive electrode active material precursor particles 100 and the lithium source 200 including lithium are mixed and heat-treated to prepare a positive electrode active material 300 in which a plurality of primary particles 310 are aggregated (S130).

In the step of mixing and heat-treating the positive electrode active material precursor particle 100 and the lithium source 200, the sizes of the positive electrode active material precursor particles 100 may be controlled to control size uniformity of the primary particles 310 of the positive electrode active material 300. When the sizes of the positive electrode active material precursor particles 100 decrease, the size uniformity of the primary particles 310 of the positive electrode active material 300 may decrease. In contrast, when the sizes of the positive electrode active material precursor particles 100 increase, the size uniformity of the primary particles 310 of the positive electrode active material 300 may increase.

In addition, in the step of mixing and heat-treating the positive electrode active material precursor particles 100 and the lithium source 200, density of a central portion of the positive electrode active material 300 may be controlled by controlling the sizes of the positive electrode active material precursor particles 100. When the sizes of the positive electrode active material precursor particles 100 decrease, the density of the central portion of the positive electrode active material 300 may decrease. In contrast, when the sizes of the positive electrode active material precursor particles 100 increase, the density of the central portion of the positive electrode active material 300 may increase.

In addition, in the step of mixing and heat-treating the positive electrode active material precursor particles 100 and the lithium source 200, a grain size of the positive electrode active material 300 may be controlled by controlling the sizes of the positive electrode active material precursor particles 100. When the sizes of the positive electrode active material precursor particles 100 decrease, the grain size of the positive electrode active material 300 may increase. In contrast, when the sizes of the positive electrode active material precursor particles 100 increase, the grain size of the positive electrode active material 300 may decrease. As described below, the grain size of the positive electrode active material 300 may be controlled to be greater than 105.0 nm and less than 158.2 nm.

In addition, in the process of mixing and heat-treating the positive electrode active material precursor particles 100 and the lithium source 200, a chemical composition of the positive electrode active material precursor particles 100 may be changed from Ni(OH)₂ to NiO. In this case, nickel cations (Ni²⁺) of the positive electrode active material precursor particle 100 and lithium cations (Li+) of the lithium source 200 may be mixed between the positive electrode active material precursor particles 100 and the lithium source 200. The mixed degree between the cations of the nickel and the cations of the lithium is defined as a mixing level.

Therefore, in the step of mixing and heat-treating the positive electrode active material precursor particles 100 and the lithium source 200, the mixing level between the nickel cations of the positive electrode active material precursor particles 100 and the lithium cations of the lithium source 200 may be controlled by controlling the sizes of the positive electrode active material precursor particles 100 in the positive electrode active material 300. When the sizes of the positive electrode active material precursor particles 100 decrease, the mixing level between the cations of nickel and the cations of lithium in the positive electrode active material 300 may increase. In contrast, when the sizes of the positive electrode active material precursor particles 100 increase, the mixing level between the cations of nickel and the cations of lithium in the positive electrode active material 300 may decrease.

In addition, in the step of mixing and heat-treating the positive electrode active material precursor particles 100 and the lithium source 200, the sizes of the positive electrode active material precursor particles 100 may be controlled. When the sizes of the positive electrode active material precursor particles 100 decrease, the generation rate of the primary particles 310 of the positive electrode active material 300 may increase. In contrast, when the sizes of the positive electrode active material precursor particles 100 increase, the generation rate of the primary particles 310 of the positive electrode active material 300 may decrease.

According to the one embodiment, when the size of the positive electrode active material precursor particle 100 is controlled to 8 um or less, the generation rate of the primary particles 310 of the positive electrode active material 300 may exceed a reference generation rate. In this case, the particle size of the positive electrode active material 300 may be controlled to 8 um or less, and a portion of the primary particles 310 of the positive electrode active material 300 may be decomposed. Accordingly, rate-limiting characteristics of a lithium secondary battery described later and stability with respect to a charging/discharging cycle may be reduced.

In contrast, when the size of the positive electrode active material precursor particle 100 is controlled to be greater than 4 um and less than 16 um, the generation rate of the primary particles 310 of the positive electrode active material 300 may be the reference generation rate. In this case, the particle size of the positive electrode active material 300 may be controlled to be greater than 4 um and less than 16 um, and the positive electrode active material 300 may have a stable crystal structure. Accordingly, the rate-limiting characteristics of the lithium secondary battery described later and the stability with respect to the charging/discharging cycle may be improved.

On the other hand, when the size of the positive electrode active material precursor particle 100 is controlled to be 16 um or more, the generation rate of the primary particles 310 of the positive electrode active material 300 may be less than the reference generation rate. In this case, the particle size of the positive electrode active material 300 may be controlled to 16 um or more, and the primary particles 310 in which the positive electrode active material precursor particles 100 and the lithium source 200 are not reacted may be present in the positive electrode active material 300. Accordingly, the rate-limiting characteristics of the lithium secondary battery described later and the stability with respect to the charging/discharging cycle may be reduced.

Therefore, in the step of mixing and heat-treating the positive electrode active material precursor particles 100 and the lithium source 200 according to the one embodiment of the present invention, the size of the positive electrode active material precursor particles 100, as described above, may be controlled to be greater than 4 um and less than 16 um. Accordingly, the particle size of the positive electrode active material 300 may be controlled to be greater than 4 um and less than 16 um, and the positive electrode active material 300 may have a stable crystal structure. Accordingly, the rate-limiting characteristics of the lithium secondary battery described later and the stability with respect to the charging/discharging cycle may be improved.

In addition, in the step of mixing and heat-treating the positive electrode active material precursor particles 100 and the lithium source 200, the provided oxygen partial pressure may be controlled to control the crystal structure of the positive electrode active material 300.

The crystal structure of the positive electrode active material 300 may include a (003) plane and a (104) plane. The (003) plane is a Layered Structure Phase, and the (104) plane is a phase in which a Layered Structure Phase and a Rock Salt Type Phase are mixed. When the positive electrode active material 300 includes more Layered Structure Phases of the (003) plane, the positive electrode active material 300 may have a stable crystal structure.

The (003) plane and the (104) plane of the positive electrode active material 300 may be analyzed using X-ray diffraction (XRD). In XRD, a peak value corresponding to the (003) plane is 1003, and a peak value corresponding to the (104) plane is 1104. Accordingly, the crystal structure of the positive electrode active material 300 may be identified through the ratio of I₀₀₃/I₁₀₄.

As described above, the size of the positive electrode active material precursor particle 100 may be controlled to be greater than 4 um and less than 16 um.

According to the one embodiment, when the oxygen partial pressure is controlled to be 0.3 L/min or less, the I₀₀₃/I₁₀₄ of the positive electrode active material 300 may be less than 1.74 (reference I₀₀₃/I₁₀₄).

Accordingly, the positive electrode active material 300 may have an unstable crystal structure due to a decrease in the Layered Structure Phase, compared to the reference I₀₀₃/I₁₀₄. Accordingly, rate-limiting characteristics and stability with respect to a charging/discharging cycle of a lithium secondary battery, which will be described later, may be reduced.

In contrast, when the oxygen partial pressure is controlled to be greater than 0.3 L/min and less than 1.0 L/min, the I_{00f}/I₁₀₄ of the positive electrode active material 300 may exceed 1.74 (reference I₀₀₃/I₁₀₄). Accordingly, the positive electrode active material 300 may have a stable crystal structure due to an increase in the Layered Structure Phase, compared to the reference I₀₀₃/I₁₀₄. Accordingly, rate-limiting characteristics and stability with respect to a charging/discharging cycle of a lithium secondary battery, which will be described later, may be improved.

On the other hand, when the oxygen partial pressure is controlled to be greater than 1.0 L/min, the I₀₀₃/I₁₀₄ of the positive electrode active material 300 may be less than 1.74 (reference I₀₀₃/I₁₀₄). Thus, the positive electrode active material 300 may have an unstable crystal structure due to a decrease in the Layered Structure Phase, compared to the reference I₀₀₀₃/I₁₀₄. Accordingly, rate-limiting characteristics and stability with respect to a charging/discharging cycle of a lithium secondary battery, which will be described later, may be reduced.

Therefore, in the step of mixing and heat-treating the positive electrode active material precursor particles 100 and the lithium source 200, the oxygen partial pressure may be controlled to be greater than 0.3 L/min and less than 1.0 L/min. Accordingly, the positive electrode active material 300 may have a stable crystal structure due to an increase in the Layered Structure Phase, compared to the reference I₀₀₃/I₁₀₄. Accordingly, rate-limiting characteristics and stability with respect to a charging/discharging cycle of a lithium secondary battery, which will be described later, may be improved.

In addition, in the step of mixing and heat-treating the positive electrode active material precursor particles 100 and the lithium source 200, the crystal structure of the positive electrode active material 300 may be controlled by controlling the molar ratio of lithium in the lithium source 200.

As described above, the size of the positive electrode active material precursor particle 100 may be controlled to be greater than 4 um and less than 16 um.

According to the one embodiment, when the molar ratio between the nickel of the positive electrode active material precursor particles 100 and the lithium of the lithium source 200 is controlled to be 1:1.01 or less, the I₀₀₃/I₁₀₄ of the positive electrode active material 300 may be less than 1.74 (reference I₀₀₃/I₁₀₄). Therefore, the positive electrode active material 300 may have an unstable crystal structure due to a decrease in the Layered Structure Phase, compared to the reference I₀₀₃/I₁₀₄. Accordingly, rate-limiting characteristics and stability with respect to a charging/discharging cycle of a lithium secondary battery, which will be described later, may be reduced.

In contrast, when the molar ratio of the nickel of the positive electrode active material precursor particle 100 and the lithium of the lithium source 200, as described above, is controlled to be more than 1:1.01 and less than 1.05, the I₀₀₃/I₁₀₄ of the positive electrode active material 300 may exceed 1.74 (reference I₀₀₃/I₁₀₄). Accordingly, the positive electrode active material 300 may have a stable crystal structure due to an increase in the Layered Structure Phase, compared to the reference I₀₀₃/I₁₀₄. Accordingly, rate-limiting characteristics and stability with respect to a charging/discharging cycle of a lithium secondary battery, which will be described later, may be improved.

On the other hand, when the molar ratio of nickel of the positive electrode active material precursor particles 100 and lithium of the lithium source 200 is controlled to be 1.1.05 or more, the I₀₀₃/I₁₀₄ of the positive electrode active material 300 may be less than 1.74(reference I₀₀₃/I₁₀₄). Therefore, the positive electrode active material 300 may have an unstable crystal structure due to a decrease in the Layered Structure Phase, compared to the reference I₀₀₃/I₁₀₄. Accordingly, rate-limiting characteristics and stability with respect to a charging/discharging cycle of a lithium secondary battery, which will be described later, may be reduced.

Therefore, in the step of mixing and heat-treating the positive electrode active material precursor particles 100 and the lithium source 200, the molar ratio between nickel in the positive electrode active material precursor particles 100 and lithium in the lithium source 200 may be controlled to be greater than 1:1.01 and less than 1.05. Accordingly, the positive electrode active material 300 may have a stable crystal structure. Accordingly, rate-limiting characteristics and stability with respect to a charging/discharging cycle of a lithium secondary battery, which will be described later, may be improved. Further, in conclusion, in the step of mixing and heat-treating the positive electrode active material precursor particles 100 and the lithium source 200, the sizes of the positive electrode active material precursor particles 100 may be controlled to control the size uniformity and generation rate of the primary particles of the positive electrode active material 300, and the grain size, core density, and mixing level of the positive electrode active material 300. In addition, the crystal structure of the positive electrode active material precursor particles 100 may be controlled by controlling the oxygen partial pressure and the molar ratio of the lithium source 200. Accordingly, the method for preparing the positive electrode active material 300 of the present invention may provide a positive electrode active material 300 having improved rate-limiting characteristics and stability with respect to a charging/discharging cycle of the lithium secondary batter described later.

In addition, the method for preparing the positive electrode active material 300 according to the present invention may include providing and co-precipitating the precursor source 110, the reducing agent 120, and the pH adjusting agent 130 to the reactor 140, and mixing and heat-treating the positive electrode active material precursor particles 100 and the lithium source 200. Accordingly, the preparing time of the positive electrode active material 300 may be shortened, and the preparing cost may be reduced, so that the positive electrode active material 300 may be easily mass produced.

Referring to FIG. 6, the positive electrode active material 300 and the primary particles 310 of the positive electrode active material 300 will be described.

The positive electrode active material 300 may include spherical secondary particles in which the primary particles 310 are aggregated. For example, the chemical composition of the positive electrode active material 300 may be LiNiO2.

The size of the secondary particle of the positive electrode active material 300 may be derived from the size of the positive electrode active material precursor particle 100. In other words, the size of the secondary particle of the positive electrode active material 300 may be substantially the same as the size of the positive electrode active material precursor particle 100. Thus, as described above, when the size of the positive electrode active material precursor particle 100 is controlled to be greater than 4 um and less than 16 um, the size of the secondary particle of the positive electrode active material 300 may be controlled to be greater than 4 um and less than 16 um. Accordingly, a grain size of the secondary particle of the positive electrode active material 300 may be, as described above, greater than 105.0 nm and less than 158.2 nm.

As a result of measuring the peak intensities of the (003) plane and the (104) plane of the positive electrode active material 300, the positive electrode active material 300 may exceed 1.74 (reference I₀₀₃/I₁₀₄). Accordingly, the positive electrode active material 300 may have a stable crystal structure due to an increase in the Layered Structure Phase, compared to the reference I₀₀₃/I₁₀₄. Accordingly, when the positive electrode active material 300 is applied to the lithium secondary battery, lithium ions may be easily deintercalated/intercalated due to the stable crystal structure of the positive electrode active material 300. As a result, the rate-limiting characteristics of the lithium secondary battery of the lithium secondary battery and the stability of the charging/discharging cycle may be improved.

Hereinafter, specific experimental examples and characteristic evaluation results of the positive electrode active material according to the embodiments of the present invention will be described.

### Preparation of Positive Electrode Active Material According to Experimental Example 1

NiSO₄·6H₂O (2M) as a precursor source including nickel, NH₄OH (3M) as a reducing agent, NaOH (5M) as a pH adjusting agent, and LiOH·H2O as a lithium source are prepared.

The precursor source (NiSO₄·6H₂O (2M)), the reducing agent (NH₄OH (3M)), and the pH adjusting agent (NaOH (5M)) are provided in a 2 L of volumetric flask and mixed to prepare a positive electrode active material precursor source solution.

The positive electrode active material precursor source solution is provided to a 10 L of batch reactor, and a co-precipitation process is performed under conditions of pH 11.1, stirring speed 900 RPM, stirring temperature 45.5° C., and stirring time 24 hours in a nitrogen atmosphere.

The particles generated in the positive electrode active material precursor source solution are collected using a centrifuge, washed by D.I water, and then dried at 60° C. for 12 hours or more to prepare positive electrode active material precursor particles (Ni(OH)₂-4) having a particle size of 4 um.

Then, the positive electrode active material precursor particles and the lithium source are mixed and provided to a tube furnace in an oxygen atmosphere so that the molar ratio of nickel of the positive electrode active material precursor particles and lithium of the lithium source is 1:1.03.

The temperature of the tube furnace is raised from room temperature to 500° C. at 2° C./min, followed by primary heat-treatment for 5 hours, and then raised from 500° C. to 650° C. at 2° C./min, followed by secondary heat-treatment for 10 hours, thereby preparing a positive electrode active material (LNO-4) having a particle size of 4 um.

### Preparation of Positive Electrode Active Material According to Experimental Example 2

A positive electrode active material (LNO-8) having a particle size of 8 um is prepared by performing the same method for preparing the positive electrode active material as in Experimental Example 1, except that a positive electrode active material precursor particle (Ni(OH)₂-8) having a particle size of 8 um is prepared by providing a positive electrode active material precursor source solution to a 10 L of batch reactor, and performing a co-precipitation process under conditions of pH 11.1, 45° C., 900 RPM stirring speed, and 48 hours stirring time in a nitrogen atmosphere.

### Preparation of Positive Electrode Active Material According to Experimental Example 3

A positive electrode active material (LNO-12) having a particle size of 12 um is prepared by performing the same method for preparing a positive electrode active material as in Experimental Example 1, except that a positive electrode active material precursor particle (Ni(OH)₂-12) having a particle size of 12 um is prepared by providing a positive electrode active material precursor solution to a 10 L of batch reactor, and performing a co-precipitation process under conditions of pH 10.8, 45.5° C., 800 RPM stirring speed, and 48 hours stirring time in a nitrogen atmosphere.

### Preparation of Positive Electrode Active Material According to Experimental Example 4

A positive electrode active material (LNO-16) having a particle size of 16 um is prepared by performing the same method for preparing a positive electrode active material as in Experimental Example 1, except that a positive electrode active material precursor particle (Ni(OH)₂-16) having a particle size of 16 um is prepared by providing a positive electrode active material precursor solution to a 10 L of batch reactor, and performing a co-precipitation process under conditions of 10.5 of pH, 45.5° C., 600 RPM of stirring speed, and 48 hours of stirring time in a nitrogen atmosphere.

TABLE 1

| | Positive electrode | | Co-precipitation | | |
|---|---|---|---|---|---|
| | active material | Positive electrode | process condition | | |
| | precursor | active material | | Stirring | Stirring |
| Items | particle size | particle size | pH | speed | time |
| Experimental | 4 um(Ni(OH)₂-4) | 4 um(LNO-4) | 11.1 | 900 RPM | 24 Hours |
| Example 1 | | | | | |
| Experimental | 8 um(Ni(OH)₂-8) | 8 um(LNO-8) | 11.1 | 900 RPM | 48 Hours |
| Example 2 | | | | | |
| Experimental | 12 um(Ni(OH)₂-12) | 12 um(LNO-12) | 10.8 | 800 RPM | 48 Hours |
| Example 3 | | | | | |
| Experimental | 16 um(Ni(OH)₂-16) | 16 um(LNO-16) | 10.5 | 600 RPM | 48 Hours |
| Example 4 | | | | | |

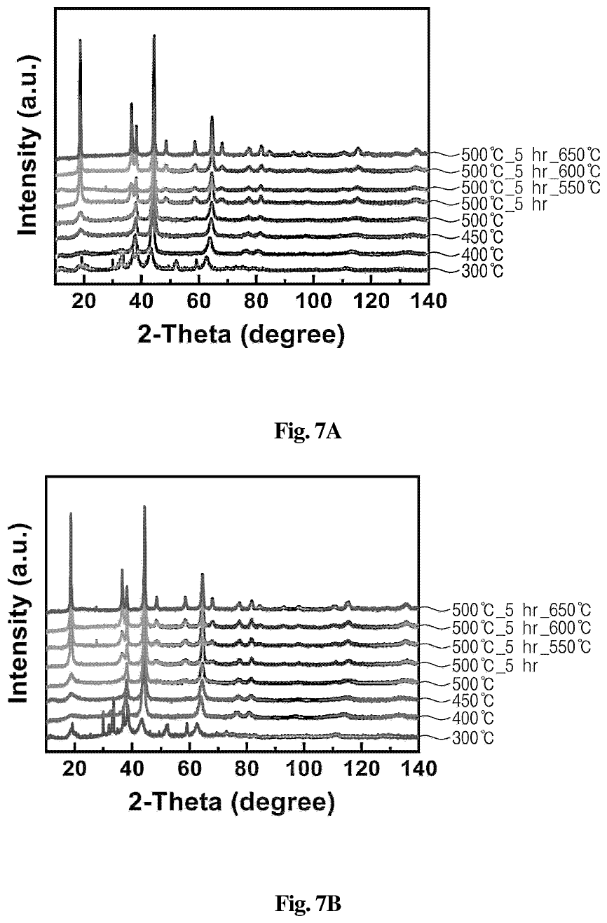

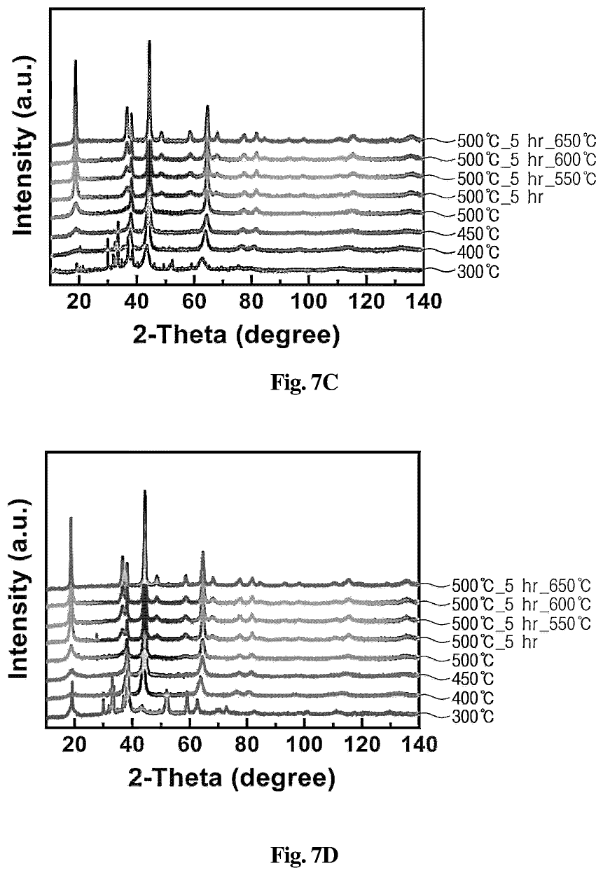

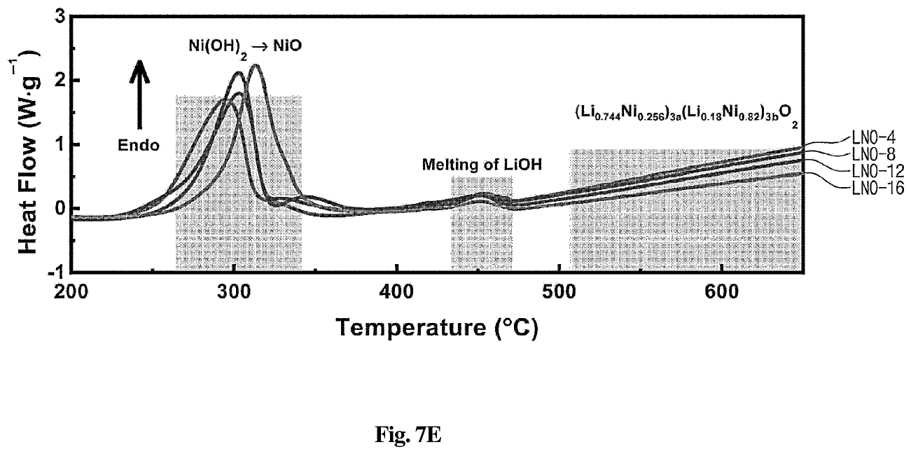

FIG. 7A is a graph obtained by XRD-analyzing a process of heat-treating positive electrode active material precursor particles and a lithium source according to Experimental Example 1 of the present invention; FIG. 7B is a graph obtained by XRD-analyzing a process of heat-treating positive electrode active material precursor particles and a lithium source according to Experimental Example 2 of the present invention; FIG. 7C is a graph obtained by XRD-analyzing a process of heat-treating positive electrode active material precursor particles and a lithium source according to Experimental Example 3 of the present invention; FIG. 7D is a graph obtained by XRD-analyzing a process of heat-treating positive electrode active material precursor particles and a lithium source according to Experimental Example 4 of the present invention; and FIG. 7E is a graph obtained by analyzing, through differential scanning calorimetry (DSC), a process of heat-treating positive electrode active material precursor particles and a lithium source according to Experimental Examples 1 to 4 of the present invention.

Referring to FIGS. 7A to 7D, processes of heat-treating the positive electrode active material precursor particles and the lithium source according to Experimental Examples 1 to 4 for each heat-treatment condition (300° C., 400° C., 450° C., 500° C., 5 hours of 500° C., 5 hours of 500° C.+550° C., 5 hours of 500° C.+600° C., 5 hours of 500° C.+650° C.) are analyzed using XRD. Referring to FIG. 7E, processes of heat-treating the positive electrode active material precursor particles and the lithium source according to Experimental Examples 1 to 4 are analyzed using DSC.

As shown in FIGS. 7A to 7E, it can be seen that the positive electrode active material precursor particles and the lithium source according to Experimental Examples 1 to 4 perform an endothermic reaction.

Referring to a red shaded region in FIG. 7E, it can be seen that the smaller the size of the positive electrode active material precursor particle, the faster the generation rate of the primary particles of the positive electrode active material.

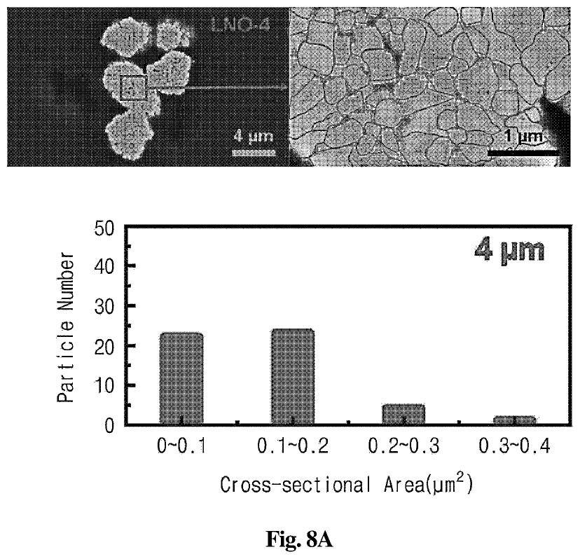

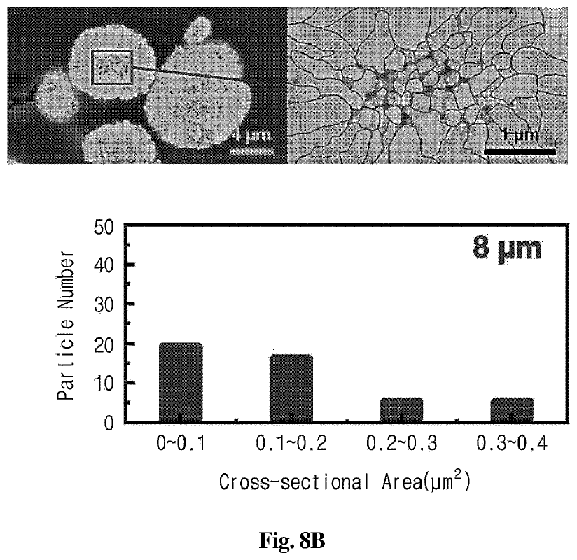

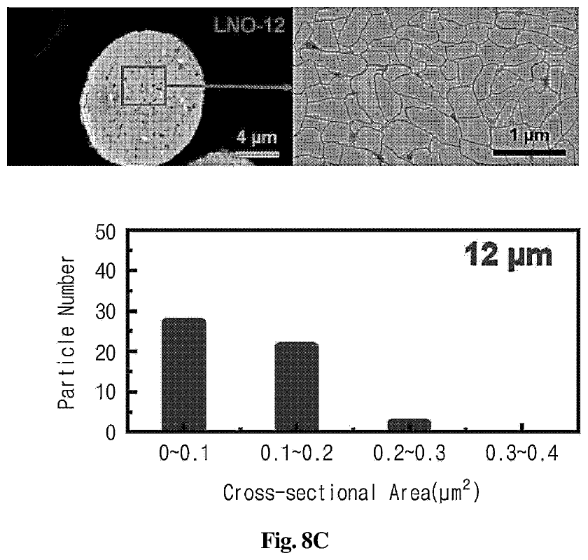

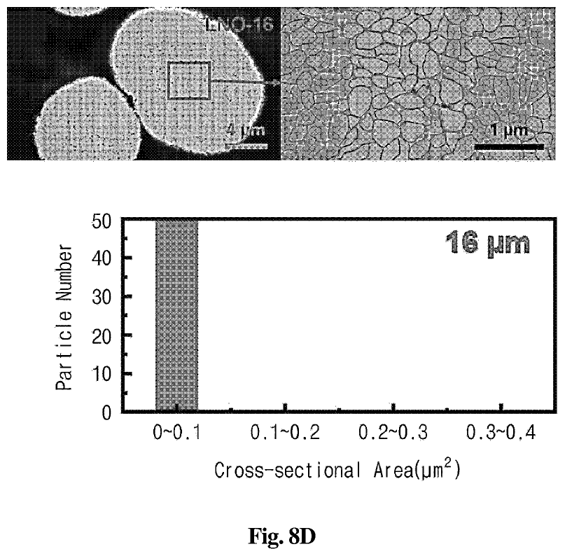

FIG. 8A is a sectional SEM photograph of a positive electrode active material according to Experimental Example 1 of the present invention and a graph showing a sectional area distribution of primary particles of the positive electrode active material; FIG. 8B is a sectional SEM photograph of a positive electrode active material according to Experimental Example 2 of the present invention and a graph showing a sectional area distribution of primary particles of the positive electrode active material; FIG. 8C is a sectional SEM photograph of a positive electrode active material according to Experimental Example 3 of the present invention and a graph showing a sectional area distribution of primary particles of the positive electrode active material; and FIG. 8D is a sectional SEM photograph of a positive electrode active material according to Experimental Example 4 of the present invention and a graph showing a sectional area distribution of primary particles of the positive electrode active material.

Referring to FIGS. 8A to 8D, the particles of the positive electrode active material according to Experimental Examples 1 to 4 are cross cut, and sections of the particles of the positive electrode active material according to Experimental Examples 1 to 4 are photographed using SEM. In addition, the sectional area sizes of the primary particles of the positive electrode active material according to Experimental Examples 1 to 4 are measured, and the sectional area distribution is shown as a graph.

As shown in FIGS. 8A to 8D, it can be seen that the primary particles in the central portion of the positive electrode active material according to Experimental Examples 1 and 2 have sizes smaller than the primary particles in the peripheral portion of the positive electrode active material.

In contrast, it can be seen that the sizes of the primary particles in the central portion of the positive electrode active material and the primary particles in the peripheral portion of the positive electrode active material according to Experimental Examples 3 and 4 are substantially similar to each other.

Accordingly, it can be seen that the density of the center portion of the positive electrode active material according to Experimental Examples 1 and 2 is lower than the density of the center portion of the positive electrode active material according to Experimental Examples 3 and 4.

Thus, it can be seen that as the size of the positive electrode active material precursor particle increases, the size of the positive electrode active material becomes uniform, and the density of the central portion of the positive electrode active material increases.

This is because the generation rate of the primary particles of the positive electrode active material is controlled according to the size of the positive electrode active material precursor particles as the precursors of the positive electrode active material.

Accordingly, it can be seen that as the size of the precursor particle of the positive electrode active material increases, the size of the positive electrode active material becomes uniform, and the density of the central portion of the positive electrode active material increases.

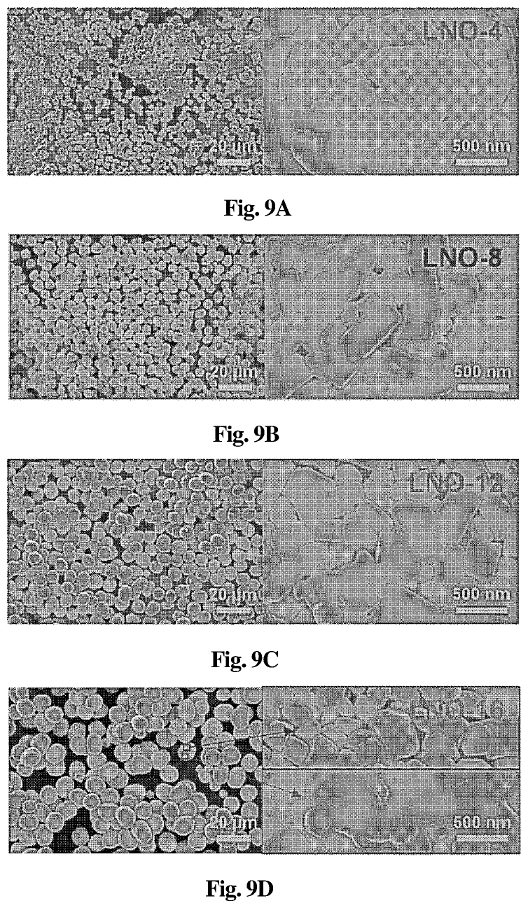

FIG. 9A is an SEM photograph of a positive electrode active material according to Experimental Example 1 of the present invention; FIG. 9B is an SEM photograph of a positive electrode active material according to Experimental Example 2 of the present invention; FIG. 9C is an SEM photograph of a positive electrode active material according to Experimental Example 3 of the present invention; and FIG. 9D is an SEM photograph of a positive electrode active material according to Experimental Example 4 of the present invention.

Referring to FIG. 9A to FIG. 9D, surfaces of the positive electrode active materials according to Experimental Examples 1 to 4 are photographed using SEM.

As shown in FIG. 9A to FIG. 9D, it can be seen that the boundary between the primary particles of the positive electrode active material according to Experimental Examples 2 and 3 is more clearly observed than the boundary between the primary particles of the positive electrode active material according to Experimental Examples 1 and 4.

This is because the generation rate of the primary particles of the positive electrode active material is controlled according to the size of the positive electrode active material precursor particles.

In this regard, referring to the red shaded region in FIG. 7E, it can be seen that the smaller the size of the positive electrode active material precursor particle, the faster the generation rate of the primary particles of the positive electrode active material.

Therefore, it can be seen that the generation rate of the primary particles of the positive electrode active material according to Experimental Example 1 is the fastest. However, it can be seen that due to the generation rate of the primary particles of the positive electrode active material faster than the reference rate, decomposition of the primary particles of the positive electrode active material occurs, and thus it is difficult to distinguish the boundary between the primary particles of the positive electrode active material.

In contrast, it can be seen that the generation rate of primary particles of the positive electrode active material according to Experimental Example 4 is the slowest. Accordingly, it can be seen that there is a portion in which the positive electrode active material precursor particles according to Experimental Example 4 and the lithium source are not reacted, and thus it is difficult to distinguish the boundary portion between the primary particles of the positive electrode active material.

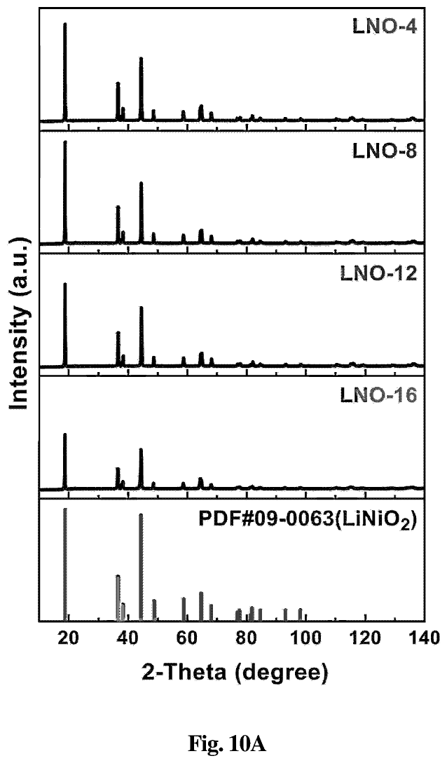

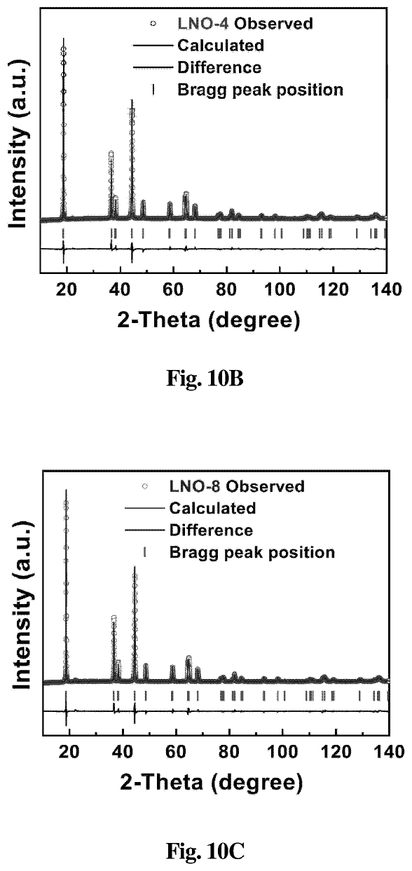

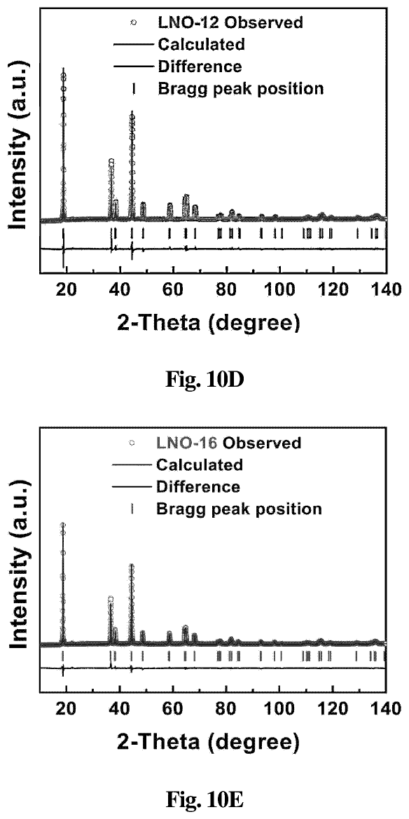

FIG. 10A shows graphs resulted from XRD analysis on positive electrode active materials according to Experimental Examples 1 to 4 of the present invention; FIG. 10B is a graph obtained by performing XRD analysis and Rietveld Refinement on a positive electrode active material according to Experimental Example 1 of the present invention; FIG. 10C is a graph obtained by performing XRD analysis and Rietveld Refinement on a positive electrode active material according to Experimental Example 2 of the present invention; FIG. 10D is a graph obtained by performing XRD analysis and Rietveld Refinement on a positive electrode active material according to Experimental Example 3 of the present invention; and FIG. 10E is a graph obtained by performing XRD analysis and Rietveld Refinement on a positive electrode active material according to Experimental Example 4 of the present invention.

Referring to FIG. 10A, the positive electrode active materials according to Experimental Examples 1 to 4 are analyzed using XRD. Referring to FIGS. 10B to 10E and Table 2 below, results on XRD analysis of the positive electrode active materials according to Experimental Examples 1 to 4 and rietveld refinement are summarized in Table 2 below.

As shown in FIGS. 10A to 10E and Table 2, it can be seen that intensity of the peak related to the crystal structure of LiNiO2 increases when the size of the particles of the positive electrode active materials according to Experimental Examples 1 to 4 decreases. Therefore, it can be seen that the smaller the particle size of the positive electrode active material, the greater the crystallinity of the positive electrode active material.

This is due to the fact that the generation rate of the primary particles of the positive electrode active material is controlled according to the size of the positive electrode active material precursor particles.

In this regard, referring to the red shaded region in FIG. 7E, it can be seen that the smaller the size of the positive electrode active material precursor particle, the faster the generation rate of the primary particles of the positive electrode active material.

Therefore, it can be seen that the smaller the size of the positive electrode active material precursor particle, the faster the generation rate of the primary particles of the positive electrode active material, and thus the crystallinity of the positive electrode active material increases.

TABLE 2

| | Lattice Parameter | | | Graub | | | |
|---|---|---|---|---|---|---|---|
| Items | A | C | c/a | size(nm) | GOF | Li/Ni | Li_{1-z}Ni_{1+z}O₂ |
| Experimental | 2.8765 | 14.1938 | 4.9344 | 160.4 | 3.40 | 0.868 | Li_{0.934}Ni_{1.066}O₂ |
| Example | | | | | | | |
| 1(LNO-4) | | | | | | | |
| Experimental | 2.8749 | 14.1888 | 4.93551 | 158.2 | 3.25 | 0.976 | Li_{0.988}Ni_{1.012}O₂ |
| Example | | | | | | | |
| 2(LNO-8) | | | | | | | |
| Experimental | 2.8728 | 14.1894 | 4.93921 | 116.3 | 3.38 | 0.987 | Li_{0.993}Ni_{1.007}O₂ |
| Example | | | | | | | |
| 3(LNO-12) | | | | | | | |
| Experimental | 2.8755 | 14.1971 | 4.9373 | 105.0 | 3.58 | 0.874 | Li_{0.937}Ni_{1.063}O₂ |
| Example | | | | | | | |
| 4(LNO-16) | | | | | | | |

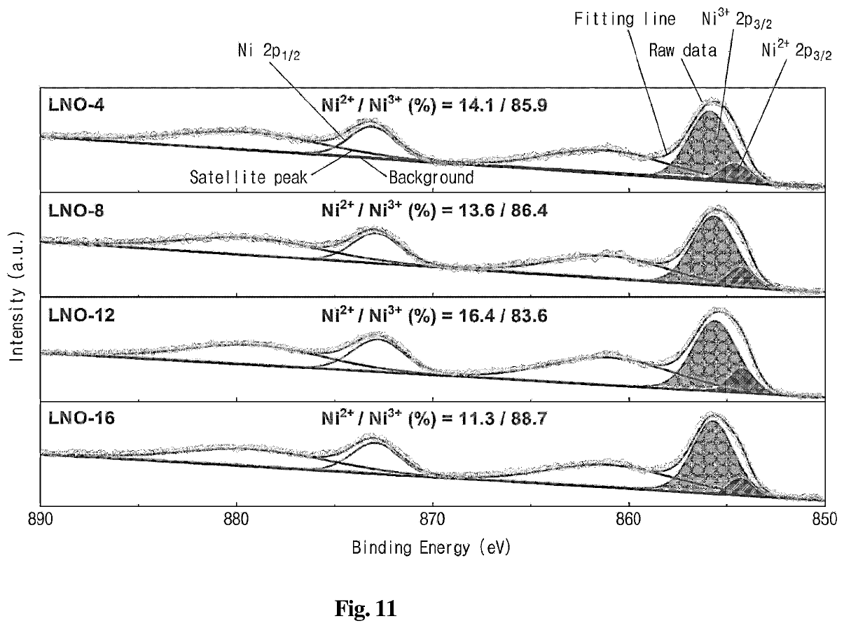

FIG. 11 shows graphs of XPS analysis of the positive electrode active materials according to Experimental Examples 1 to 4 of the present invention.

Referring to FIG. 11, Ni²⁺2p3/2 and Ni³⁺2p^{3/2} on the surfaces of the positive electrode active materials according to Experimental Examples 1 to 4 are analyzed using XPS.

As shown in FIG. 11, it can be seen that the positive electrode active material according to Experimental Example 1 is partially decomposed into Li₂O due to the fastest generation rate of primary particles of the positive electrode active material among Experimental Examples, and thus the Ni²⁺ ratio is 14%.

It can be seen that the positive electrode active material according to Experimental Example 2 has the Ni²⁺ ratio of 13.6%.

In the positive electrode active material according to Experimental Example 3, it can be seen that NiO is generated due to a reaction with oxygen on the surface of the positive electrode active material, and thus the Ni²⁺ ratio is 16.4%, which is the highest.

It can be seen that the positive electrode active material according to Experimental Example 4 has a portion in which the positive electrode active material precursor particles according to Experimental Example 4 and the lithium source are not reacted due to the slowest generation rate of the primary particles of the positive electrode active material among Experimental Examples, and thus the Ni²⁺ ratio is 11.3%.

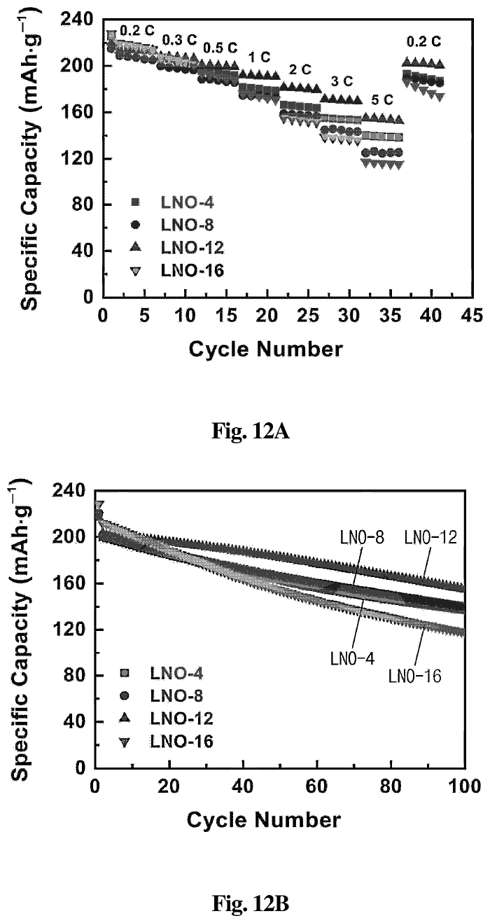

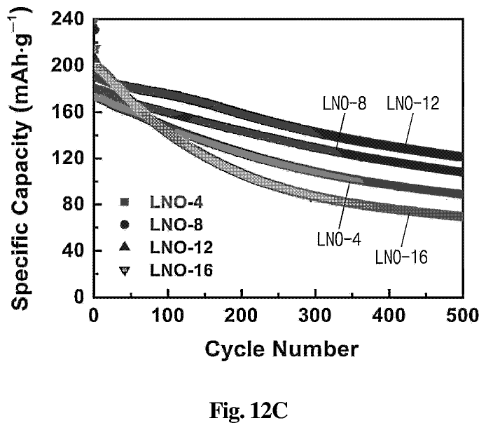

FIG. 12A is a graph for comparing rate-limiting characteristics of Full Cells to which the positive electrode active materials according to Experimental Examples 1 to 4 of the present invention are applied; FIG. 12B is a graph for comparing the specific capacity for each cycle of Half Cells to which the positive electrode active materials according to Experimental Examples 1 to 4 of the present invention are applied; and FIG. 12C is a graph for comparing the long-term stability of Full Cells to which the positive electrode active materials according to Experimental Examples 1 to 4 of the present invention are applied.

Referring to FIG. 12A, the positive electrode active materials according to Experimental Examples 1 to 4 are applied to Full Cells, and specific capacity is measured for each charging/discharging rate (0.2 C, 0.3 C, 0.5 C, 1 C, 2 C, 3 C and 5 C). Referring to FIG. 12B, the positive electrode active materials according to Experimental Examples 1 to 4 are applied to Half Cells to measure specific capacity for 100 cycles. Referring to FIG. 12C, the positive electrode active materials according to Experimental Examples 1 to 4 are applied to Half Cells to measure specific capacity for 500 cycles.

As shown in FIGS. 12A to 12C, it can be seen that specific capacity retention rate and long-term stability of the Full Cell to which the positive electrode active material according to Experimental Example 3 is applied are the most excellent.

This factor is due to the fact that the positive electrode active material according to Experimental Example 3 has the highest Ni²⁺ ratio among Experimental Examples in the XPS analysis results of FIG. 11. Accordingly, it can be seen that the Full Cell to which the positive electrode active material according to Experimental Example 3 is applied has the highest specific capacity retention rate and long-term stability, based on the Pillar Effect in the rate capability and long-term stability test on the Full Cell to which the positive electrode active material according to Experimental Example 3 is applied.

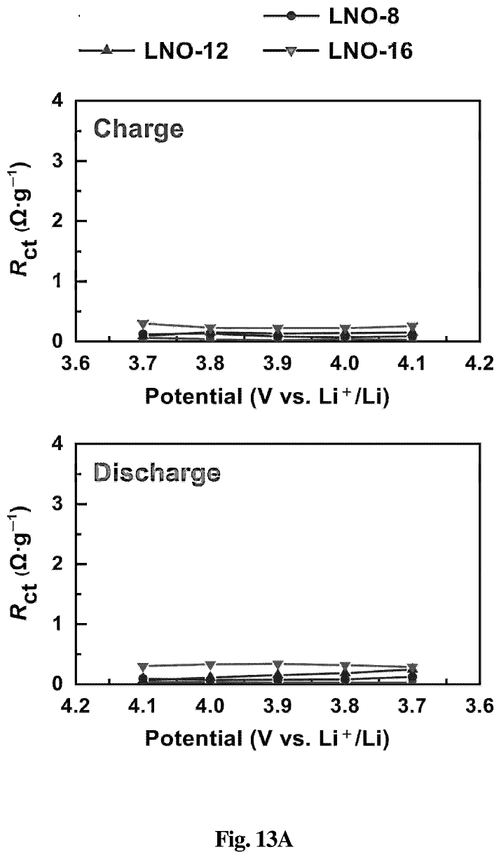

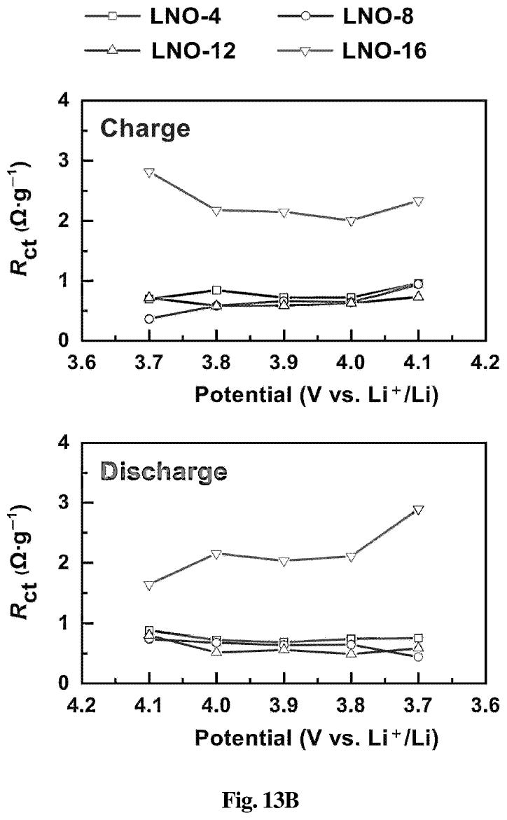

FIG. 13A is a graph for comparing R_{ct} values in initial states of Half Cells to which the positive electrode active materials according to Experimental Examples 1 to 4 of the present invention are applied; and FIG. 13B is a graph for comparing R_{ct} values after performing 100 cycles of charging/discharging of Half Cells to which the positive electrode active materials according to Experimental Examples 1 to 4 of the present invention are applied.

Referring to FIG. 13A, charging/discharging R_{ct} values are measured on Half Cells, to which the positive electrode active materials according to Experimental Examples 1 to 4 are applied, for each applied voltage in an initial state. Referring to FIG. 13B, charging/discharging R_{ct} values are measured on Half Cells, to which the positive electrode active materials according to Experimental Examples 1 to 4 are applied, for each applied voltage after 100 cycles of charging/discharging.

As shown in FIGS. 13A and 13B, it can be seen that the Half Cells to which the positive electrode active materials according to Experimental Examples 1 to 3 are applied have similar R_{ct} values after 100 cycles of charging/discharging.

In contrast, it can be seen that the Half Cell to which the positive electrode active material according to Experimental Example 4 is applied has an increased R_{ct} value compared to the R_{ct} values of Experimental Examples 1 to 3 after 100 cycles of charging/discharging.

This factor is determined to be due to the fact that the rate of production of primary particles of the positive electrode active material according to Experimental Example 4 is the slowest among Experimental Examples.

Accordingly, it can be seen that there is a portion in which the positive electrode active material precursor particles according to Experimental Example 4 and the lithium source are not reacted, and thus the R_{ct} value increased after 100 cycles of charging/discharging compared to Experimental Examples 1 to 3.

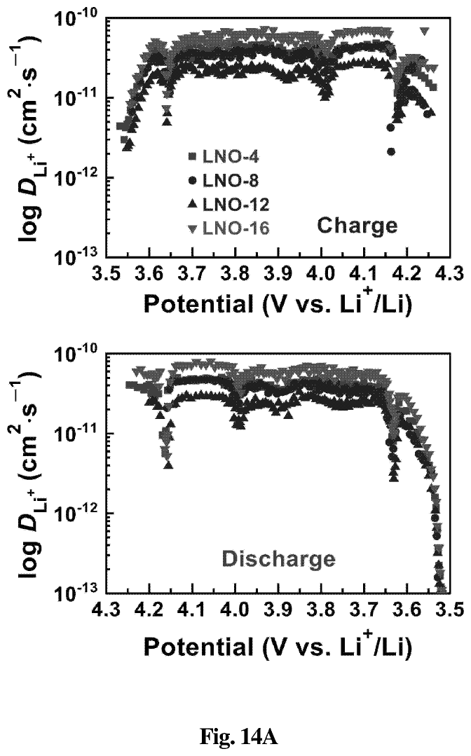

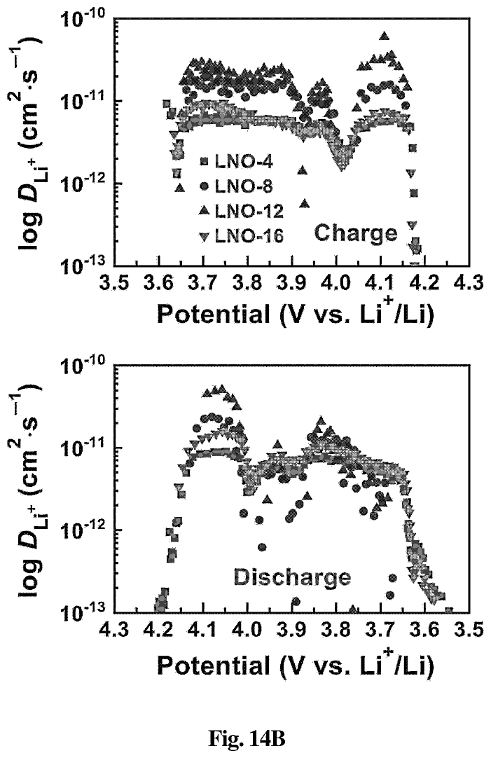

FIG. 14A shows graphs for comparing diffusion resistance of lithium ions in initial states of Half Cells to which the positive electrode active materials according to Experimental Examples 1 to 4 of the present invention are applied; and FIG. 14B shows graphs for comparing diffusion resistance of lithium ions in states after performing 100 cycles of charging/discharging of Half Cells to which the positive electrode active materials according to Experimental Examples 1 to 4 of the present invention are applied.

Referring to FIG. 14A, diffusion resistance of charging/discharging lithium ions is measured on the Half Cells, to which the positive electrode active materials according to Experimental Examples 1 to 4 are applied, for each applied voltage in an initial state. Referring to FIG. 14B, diffusion resistance of charging/discharging lithium ions is measured on the Half Cells, to which the positive electrode active materials according to Experimental Examples 1 to 4 are applied, for each applied voltage after 100 cycles of charging/discharging.

As shown in FIG. 14A, it can be seen that the diffusion resistance of lithium ions of the Half Cells, to which the positive electrode active material according to Experimental Example 4 is applied, is the lowest in an initial state. In contrast, it can be seen that the Half Cell to which the positive electrode active material according to Experimental Example 3 is applied has the highest diffusion resistance of lithium ions. This factor is determined to be due to the fact that the positive electrode active material according to Experimental Example 4 has the lowest Ni²⁺ ratio and the positive electrode active material according to Experimental Example 3 has the highest Ni²⁺ ratio, among the experimental examples in the XPS analysis results of FIG. 11.

As shown in FIG. 14B, it can be seen that the diffusion resistance of lithium ions of the Half Cell, to which the positive electrode active material according to Experimental Example 3 is applied, is the lowest after 100 cycles of charging/discharging. This factor is determined to be due to the fact that the positive electrode active material according to Experimental Example 3 has the highest Ni²⁺ ratio among Experimental Examples in the XPS analysis result of FIG. 11.

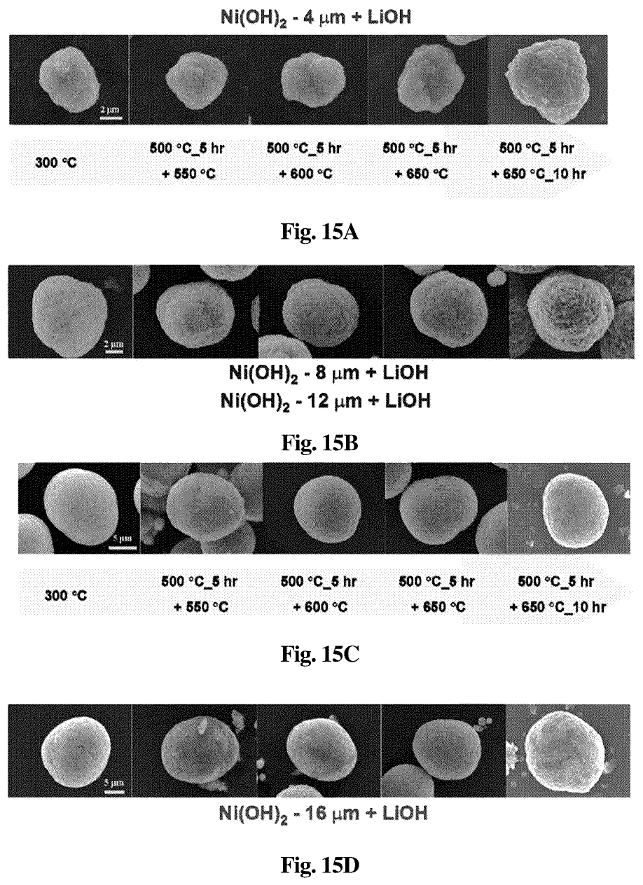

FIG. 15A shows an SEM photograph of a positive electrode active material generated under each of heat-treatment conditions of positive electrode active material precursor particles and a lithium source according to Experimental Example 1 of the present invention; FIG. 15B shows an SEM photograph of a positive electrode active material generated under each of heat-treatment conditions of positive electrode active material precursor particles and a lithium source according to Experimental Example 2 of the present invention; FIG. 15C shows an SEM photograph of a positive electrode active material generated under each of heat-treatment conditions of positive electrode active material precursor particles and a lithium source according to Experimental Example 3 of the present invention; and FIG. 15D shows an SEM photograph of a positive electrode active material generated under each of heat-treatment conditions of positive electrode active material precursor particles and a lithium source according to Experimental Example 4 of the present invention.

Referring to FIG. 15A to FIG. 15D,
the positive electrode active material precursor particles and the lithium sources according to Experimental Examples 1 to 4 are heat-treated for each heat-treatment condition (300° C., 500° C. 5 hours+550° C., 500° C. 5 hours+600° C., 500° C. 5 hours+650° C., 500° C. 5 hours+650° C. 10 hours) to prepare a positive electrode active material, and photographed by SEM.

As shown in FIG. 15A to FIG. 15D, it can be seen that, under the above heat-treatment conditions, the positive electrode active material precursor particles and the lithium source according to Experimental Example 3 are prepared as the positive electrode active material having the most spherical shape.

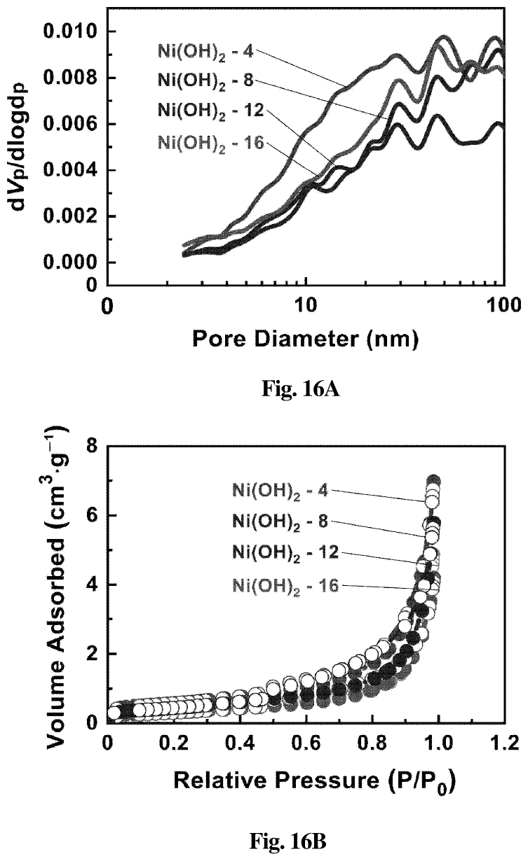

FIG. 16A and FIG. 16B are graphs obtained by measuring porosity of positive electrode active material precursor particles according to Experimental Examples 1 to 4 of the present invention by BET.

Referring to FIG. 16A, diameters of pores of the positive electrode active material precursor particles according to Experimental Examples 1 to 4 are measured using BET. Referring to FIG. 16B, the nitrogen adsorption degree of the positive electrode active material precursor particles according to Experimental Examples 1 to 4 is measured using BET.

As shown in FIG. 16A and FIG. 16B, it can be seen that the positive electrode active material precursor particles according to Experimental Examples 1 to 4 have similar porosities.

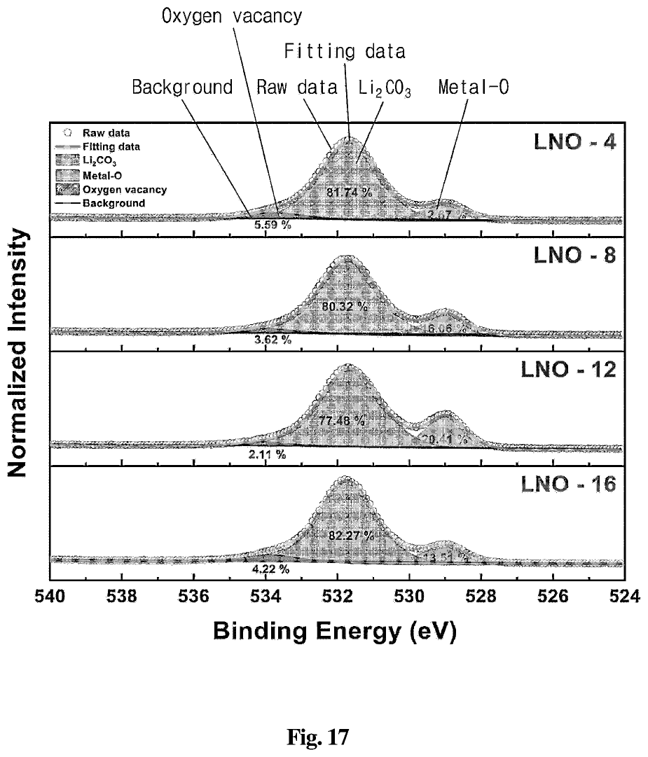

FIG. 17 is an XPS graph for comparing oxygen vacancies of positive electrode active materials according to Experimental Examples 1 to 4 of the present invention.

Referring to FIG. 17, oxygen vacancies in the positive electrode active materials according to Experimental Examples 1 to 4 are measured using XPS.

As shown in FIG. 17, it can be seen that the positive electrode active material according to Experimental Example 3 has the lowest oxygen vacancy in the order of the positive electrode active material according to Experimental Example 3, the positive electrode active material according to Experimental Example 2, the positive electrode active material according to Experimental Example 4, and the positive electrode active material according to Experimental Example 1.

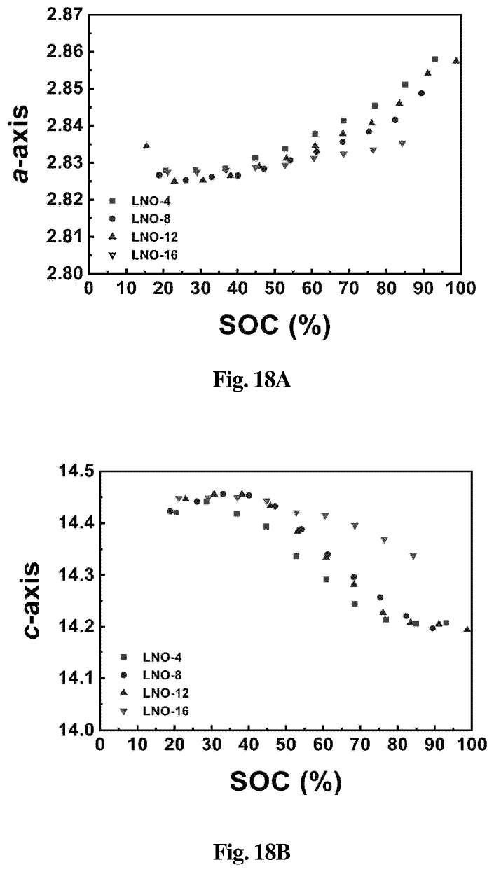

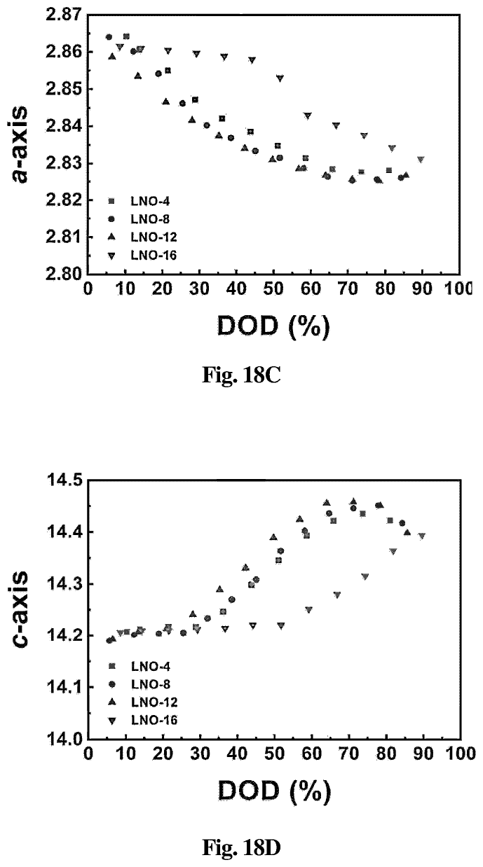

FIG. 18A shows graphs for comparing a-axis change amounts of a crystal structure of a positive electrode active material during a charging process of Half Cells to which positive electrode active materials according to Experimental Examples 1 to 4 of the present invention are applied; FIG. 18B shows graphs for comparing c-axis change amounts of a crystal structure of a positive electrode active material during a charging process of Half Cells to which the positive electrode active materials according to Experimental Examples 1 to 4 of the present invention are applied; FIG. 18C shows graphs for comparing a-axis change amounts of a lattice structure of a positive electrode active material in a discharging process of Half Cells to which positive electrode active materials according to Experimental Examples 1 to 4 of the present invention are applied; and FIG. 18D shows graphs for comparing c-axis change amounts of a lattice structure of a positive electrode active material in a discharging process of Half Cells to which positive electrode active materials according to Experimental Examples 1 to 4 of the present invention are applied.

Referring to FIGS. 18A and 18B, in the charging process of Half Cells to which the positive electrode active materials according to Experimental Examples 1 to 4 are applied, the amount of changes in the a-axis and c-axis in the crystal structures of the positive electrode active materials according to Experimental Examples 1 to 4 are calculated by performing analysis by Rietveld Refinement using XRD. Referring to FIGS. 18C and 18D, in the discharging process of Half Cells to which the positive electrode active materials according to Experimental Examples 1 to 4 are applied, the amount of changes in the a-axis and c-axis in the crystal structures of the positive electrode active materials according to Experimental Examples 1 to 4 are calculated by performing analysis by Rietveld Refinement using XRD.

As shown in FIGS. 18A to 18D, it can be seen that the Half Cell to which the positive electrode active material according to Experimental Example 4 is applied has the smallest amount of changes in the a-axis and c-axis of the positive electrode active material during the charging/discharging process.

It is determined to be due to the fact that the positive electrode active material precursor particles according to Experimental Example 4 has the largest size among the experimental examples, and thus the generation rate of the primary particles of the positive electrode active material is the slowest. Accordingly, it can be seen that there is a portion in which the positive electrode active material precursor particles and the lithium source according to Experimental Example 4 are not reacted, and thus the amount of changes in the a-axis and c-axis of the positive electrode active material is the smallest during the charging/discharging process.

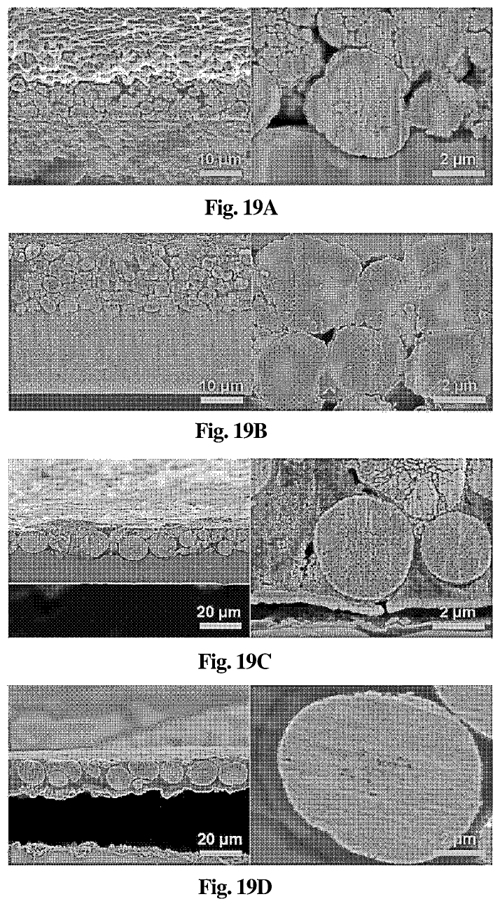

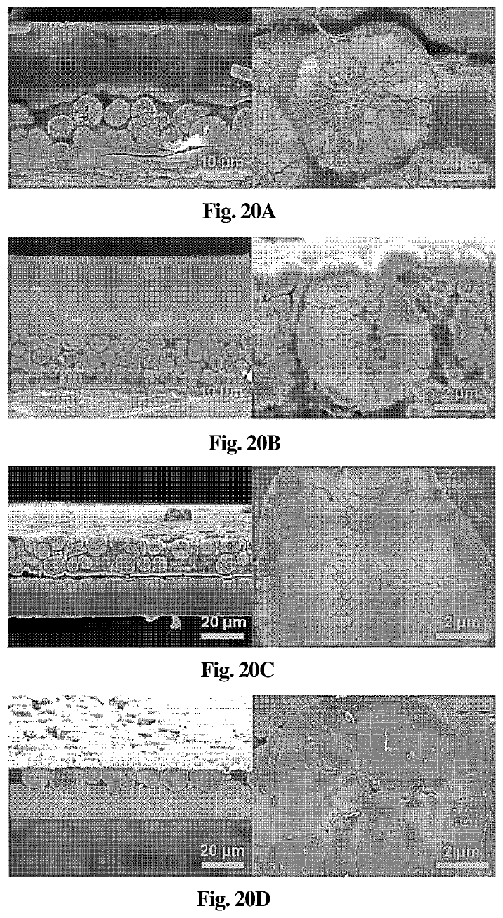

FIG. 19A is a sectional SEM photograph of a positive electrode active material after one cycle of charging/discharging of a Half Cell to which the positive electrode active material according to Experimental Example 1 of the present invention is applied; FIG. 19B is a sectional SEM photograph of a positive electrode active material after one cycle of charging/discharging of a Half Cell to which the positive electrode active material according to Experimental Example 2 of the present invention is applied; FIG. 19C is a sectional SEM photograph of a positive electrode active material after one cycle of charging/discharging of a Half Cell to which the positive electrode active material according to Experimental Example 3 of the present invention is applied; and FIG. 19D is a sectional SEM photograph of a positive electrode active material after one cycle of charging/discharging of a Half Cell to which the positive electrode active material according to Experimental Example 4 of the present invention is applied. FIG. 20A is a sectional SEM photograph of a positive electrode active material after 100 cycles of charging/discharging of a Half Cell to which the positive electrode active material according to Experimental Example 1 of the present invention is applied; FIG. 20B is a sectional SEM photograph of a positive electrode active material after 100 cycles of charging/discharging of a Half Cell to which the positive electrode active material according to Experimental Example 2 of the present invention is applied; FIG. 20C is a sectional SEM photograph of a positive electrode active material after 100 cycles of charging/discharging of a Half Cell to which the positive electrode active material according to Experimental Example 3 of the present invention is applied; and FIG. 20D is a sectional SEM photograph of a positive electrode active material after 100 cycles of charging/discharging of a Half Cell to which the positive electrode active material according to Experimental Example 4 of the present invention is applied.

Referring to FIG. 19A to FIG. 19D the Half Cells, to which the positive electrode active materials according to Experimental Examples 1 to 4 are applied, are subjected to one cycle of charging/discharging, the positive electrode active materials according to Experimental Examples 1 to 4 are cross cut, and sections of the positive electrode active materials are photographed by SEM. Referring to FIG. 20A to FIG. 20D, the Half Cells, to which the positive electrode active materials according to Experimental Examples 1 to 4 are applied, are subjected to 100 cycles of charging/discharging, the positive electrode active materials according to Experimental Examples 1 to 4 are cross cut, and sections of the positive electrode active materials are photographed by SEM.

As shown in FIG. 19A to FIG. 19D and FIG. 20A to FIG. 20D, it can be seen that no crack is found in the section of the positive electrode active material according to Experimental Example 3 only at the Half Cell, to which the positive electrode active material according to Experimental Example 3 is applied, after performing 100 cycles of charging/discharging.

Therefore, it can be seen that the positive electrode active material according to Experimental Example 3 has the most stable structure for the charging/discharging cycle among Experimental Examples.

This factor is determined to be due to the fact that the generation rate of the primary particles of the positive electrode active material is controlled according to the size of the precursor particles of the positive electrode active material.

Therefore, it can be seen that the method for controlling the size of the precursor particles of the positive electrode active material to be greater than 4 um and less than 16 um in order to control the generation rate of the primary particles of the positive electrode active material at the reference rate is a method for providing a positive electrode active material having improved stability with respect to the charging/discharging cycle.

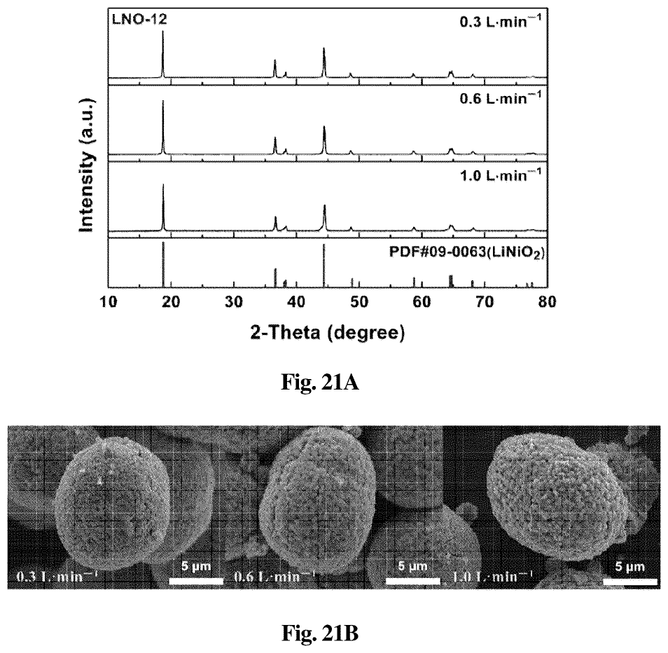

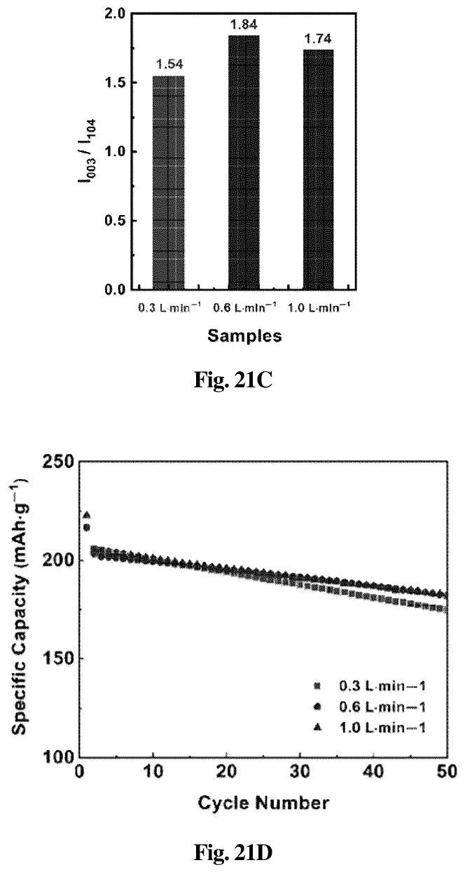

FIG. 21A is a graph of XRD analysis of a positive electrode active material prepared by controlling an oxygen flow rate in a process of heat-treating positive electrode active material precursor particles and a lithium source according to Experimental Example 3 of the present invention; FIG. 21B is an SEM photograph of a positive electrode active material prepared by controlling an oxygen flow rate in a process of heat-treating positive electrode active material precursor particles and a lithium source according to Experimental Example 3 of the present invention; FIG. 21C is a graph for comparing a ratio of (003)-plane and (104)-plane of a positive electrode active material prepared by controlling an oxygen flow rate in a process of heat-treating positive electrode active material precursor particles and a lithium source according to Experimental Example 3 of the present invention; and FIG. 21D is a graph for comparing the specific capacity for each cycle of a Half Cell to which a positive electrode active material prepared by controlling an oxygen flow rate in a process of heat-treating positive electrode active material precursor particles and a lithium source according to Experimental Example 3 of the present invention is applied.

Referring to FIG. 21A, in the process of heat-treating the positive electrode active material precursor particles and the lithium source according to Experimental Example 3, the crystal structure of the positive electrode active material prepared by controlling the oxygen flow rate to be 0.3 L/min, 0.6 L/min, and 1.0 L/min is analyzed by XRD. Referring to FIG. 21B, in the process of heat-treating the positive electrode active material precursor particles and the lithium source according to Experimental Example 3, the positive electrode active material prepared by controlling the oxygen flow rate to be 0.3 L/min, 0.6 L/min, and 1.0 L/min is photographed by SEM. Referring to FIG. 21C, in the process of heat-treating the positive electrode active material precursor particles and the lithium source according to Experimental Example 3, the crystal structure of the positive electrode active material prepared by controlling the oxygen flow rate to be 0.3 L/min, 0.6 L/min, and 1.0 L/min is analyzed by XRD and the I₀₀₃/I₁₀₄ ratio, which is the ratio between a (003) plane and a (104) plane, is calculated. Referring to FIG. 21D, in the process of heat-treating the positive electrode active material precursor particles and the lithium source according to Experimental Example 3, the oxygen flow rate is controlled to 0.3 L/min, 0.6 L/min, and 1.0 L/min, and the prepared positive electrode active material is applied to the Half Cell to measure the specific capacity at a charging/discharging rate of 0.1 C for one cycle, and measure the specific capacity of the Half Cell at a charging/discharging rate of 0.5 C for the remaining 49 cycles.

As shown in FG. 21A to FIG. 21D, it can be seen that the I₀₀₃/I₁₀₄ of the positive electrode active material prepared by controlling the oxygen flow rate to be 0.3 L/min is the highest at 1.84.

Therefore, in the process of heat-treating the positive electrode active material precursor particles and the lithium source according to Experimental Example 3, it can be seen that the positive electrode active material prepared by controlling the oxygen flow rate to be 0.3 L/min has the crystal structure of I₀₀₃ (Layered Structure Phase) more than the crystal structures of I₁₀₄ (Layered Structure Phase and Rock Salt Type Phase).

Accordingly, it can be seen that the Half Cell, to which the positive electrode active material prepared by controlling the oxygen flow rate to be 0.3 L/min is applied, has the most stable specific capacity retention rate for 50 cycles.

In conclusion, in the process of heat-treating the positive electrode active material precursor particles and the lithium source, it can be seen that the method for controlling the oxygen flow rate to be greater than 0.3 L/min and 1.0 L/min is a method for improving the stability of the crystal structure and the stability of the charging/discharging cycle of the positive electrode active material.

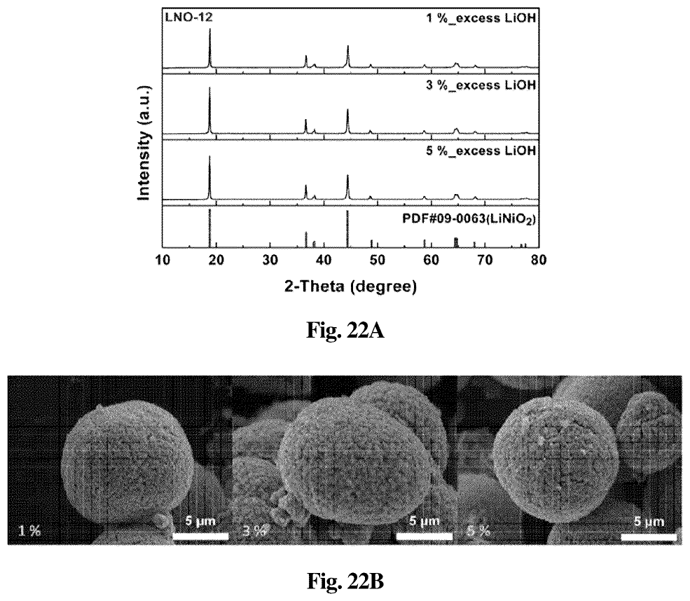

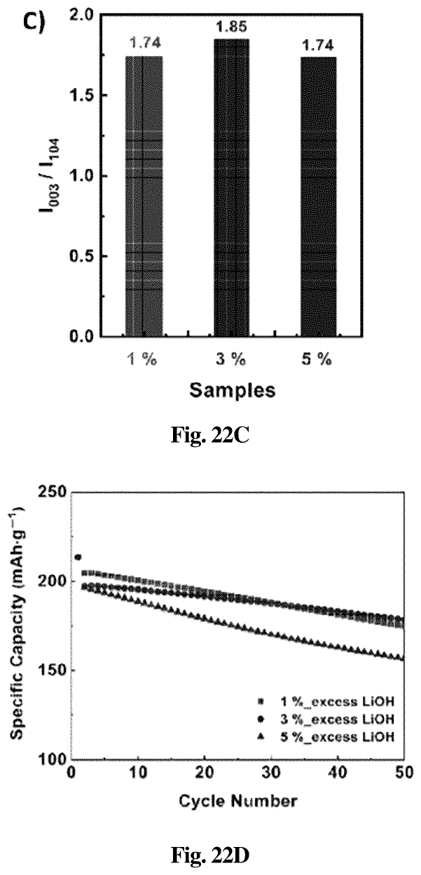

FIG. 22A is a graph of XRD analysis of a positive electrode active material prepared by controlling a molar ratio of a lithium source in a process of heat-treating positive electrode active material precursor particles and the lithium source according to Experimental Example 3 of the present invention; FIG. 22B is an SEM photograph of a positive electrode active material prepared by controlling a molar ratio of a lithium source in a process of heat-treating positive electrode active material precursor particles and the lithium source according to Experimental Example 3 of the present invention; and FIG. 22C is a graph for comparing the specific capacity for each cycle of a Half Cell to which a positive electrode active material prepared by controlling a molar ratio of a lithium source in a process of heat-treating positive electrode active material precursor particles and the lithium source according to Experimental Example 3 of the present invention is applied.

Referring to FIG. 22A, in the process of heat-treating the positive electrode active material precursor particles and the lithium source according to Experimental Example 3, the crystal structure of the positive electrode active material prepared by controlling the lithium molar ratio of the lithium source to be 1%, 3%, and 5% greater than the molar ratio of nickel of the positive electrode active material precursor particles, respectively, is analyzed by XRD. Referring to FIG. 22B, in the process of heat-treating the positive electrode active material precursor particles and the lithium source according to Experimental Example 3, the positive electrode active material prepared by controlling the lithium molar ratio of the lithium source to be 1%, 3%, and 5% greater than the molar ratio of nickel of the positive electrode active material precursor particles, respectively, is photographed by SEM. Referring to FIG. 22C, in the process of heat-treating the positive electrode active material precursor particles and the lithium source according to Experimental Example 1, the positive electrode active material prepared by controlling the lithium molar ratio of the lithium source to be 1%, 3%, and 5% greater than the molar ratio of nickel of the positive electrode active material precursor particles, respectively, is analyzed by XRD to calculate the ratio of I₀₀₃/I₁₀₄, which is the ratio of the (003) plane and the (104) plane. Referring to FIG. 21D, in the process of heat-treating the positive electrode active material precursor particles and the lithium source according to Experimental Example 1, the positive electrode active material prepared by controlling the lithium molar ratio of the lithium source to be 1%, 3%, and 5% greater than the molar ratio of nickel of the positive electrode active material precursor particles, respectively, is applied to the Half Cell, and the specific capacity of Half Cell is measured at a charging/discharging rate of 0.1 C for one cycle and the specific capacity is measured at a charging/discharging rate of 0.5 C for the remaining 49 cycles.

As shown in FIG. 22A to FIG. 22D of, it can be seen that the positive electrode active material prepared by controlling the molar ratio of the lithium source to be 3% higher than the molar ratio of nickel of the positive electrode active material precursor particles has the highest I₀₀₃/I₁₀₄ at 1.85.

Therefore, in the process of heat-treating the positive electrode active material precursor particles and the lithium source according to Experimental Example 1, it can be seen that in the positive electrode active material prepared by controlling the molar ratio of nickel to the positive electrode active material precursor particles and the lithium source to be 1:1.03 has more crystal structures of the I₀₀₃ (Layered Structure Phase) than the crystal structures of the I₁₀₄ (Layered Structure Phase and Rock Salt Type Phase).

Accordingly, it can be seen that the Half Cell, to which the positive electrode active material prepared by controlling the molar ratio of nickel of the positive electrode active material precursor particles and the lithium source to 1:1.03 is applied, has the most stable specific capacity retention rate during 50 cycles.

In conclusion, in the process of heat-treating the positive electrode active material precursor particles and the lithium source, it can be seen that the method for controlling the molar ratio of nickel of the positive electrode active material precursor particles and lithium of the lithium source to be more than 1:1.01 and less than 1:1.05 is a method for improving the stability of the crystal structure of the positive electrode active material and the stability with respect to the charging/discharging cycle.

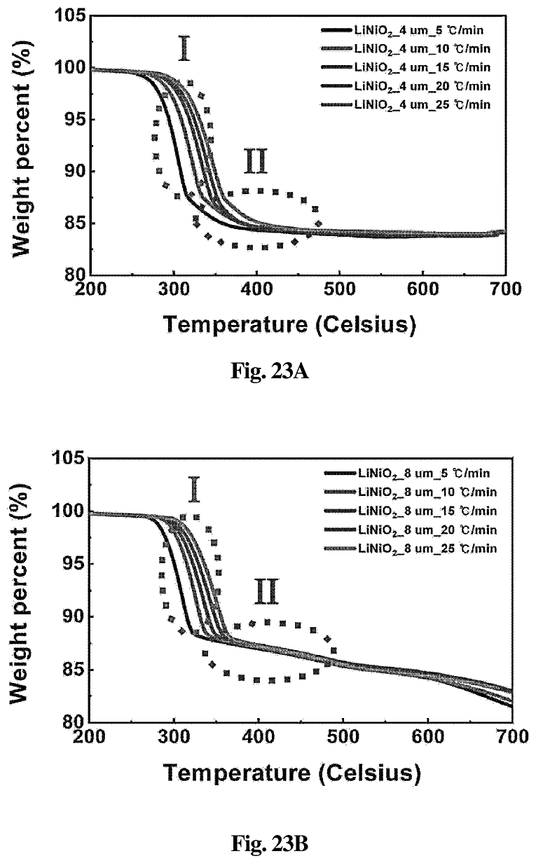

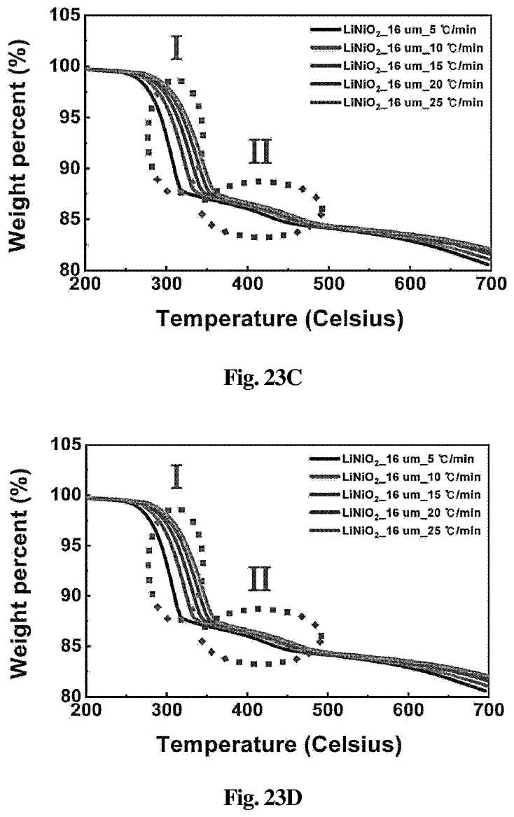

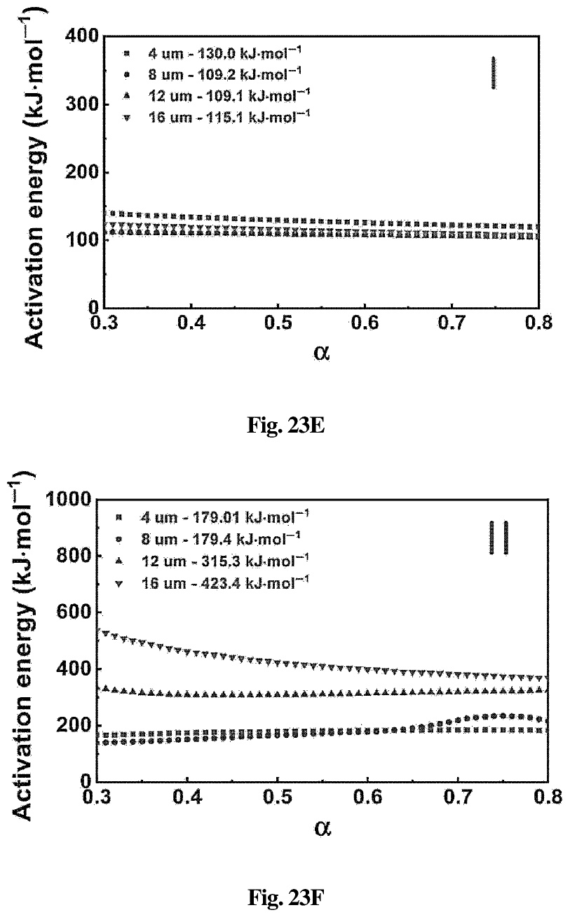

FIGS. 23A to 23D are graphs for comparing, by TGA, changes in weight of positive electrode active material precursor particles and a lithium source according to heating rates in a process of heat-treating the positive electrode active material precursor particles and the lithium source according to Experimental Examples 1 to 4 of the present invention; FIG. 23E is a graph showing activation energy for section I of FIGS. 23A to 23D; and FIG. 23F is a graph showing activation energy for section II of FIGS. 23A to 23D.

Referring to FIGS. 23A to 23D, the weight changes of the positive electrode active material precursor particles and the lithium source are measured using TGA for each temperature increase rate (5° C./min, 100 C/min, 15° C./min, 20° C./min, and 25° C./min) in the heat-treatment process of the positive electrode active material precursor particles and the lithium source according to Experimental Examples 1 to 4. Referring to FIG. 23E, activation energy of section I of FIGS. 23A to 23D (the section in which the chemical composition of the positive electrode active material precursor particles changes from Ni(OH)₂ to NiO) is calculated using the following Equation 1. Referring to FIG. 23F, activation energy of section II of FIGS. 23A to 23D (the section in which the positive electrode active material precursor particles (NiO) and the cations of the lithium source, Ni²⁺ and Li+, are mixed) is calculated using the following Equation 1.

As shown in FIGS. 23A to 23F, it can be seen that the positive electrode active material precursor particles and the lithium sources according to Experimental Examples 1 and 2 have similar activation energy in section I.

In contrast, it can be seen that the activation energy in Section II increases when the size of the positive electrode active material precursor particle increases.

Therefore, it can be seen that the positive electrode active material precursor particles according to Experimental Example 4 have the slowest generation rate of the primary particles of the positive electrode active material according to Experimental Example 4 due to the highest activation energy, and thus the Rack Salt Type Phase is present in some of the primary particles of the positive electrode active material.

In conclusion, it can be seen that the method for controlling the size of the positive electrode active material precursor particles to be greater than 4 um and less than 16 um is a method for improving the structural stability of the positive electrode active material because more Layered Structure Phases than Rack Salt Type Phases are present in the primary particles of the positive electrode active material.

ln(B/T_{f}¹⁹²)=−1.0008(E/RT_{f})+C₆₋ [Equation 1]

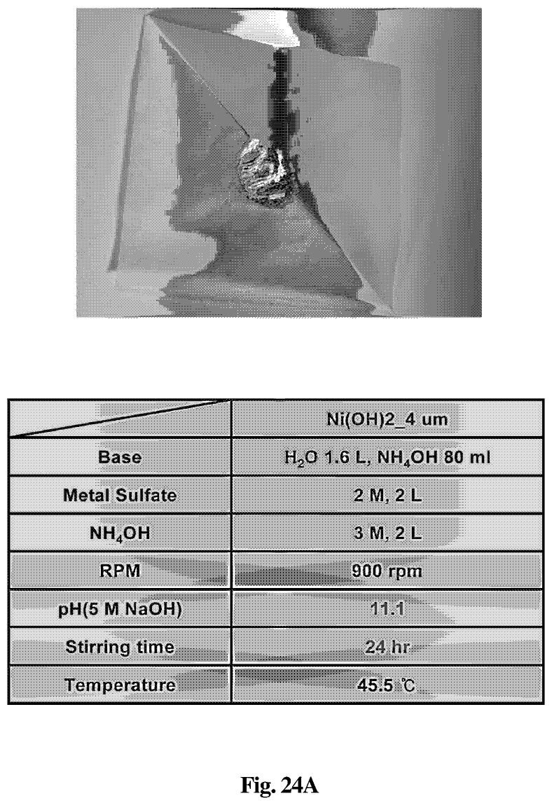

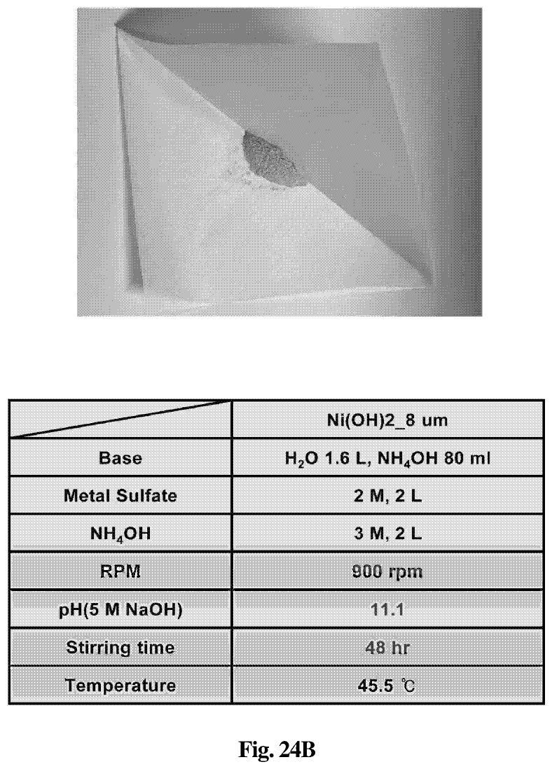

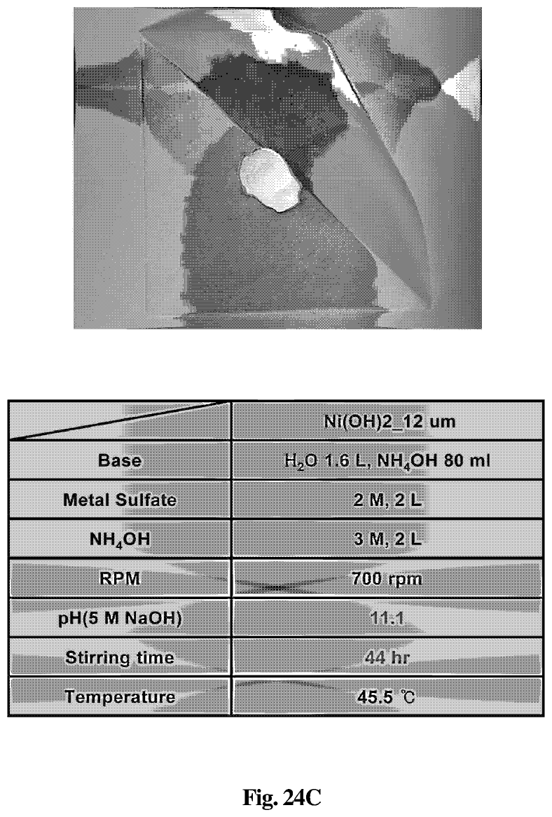

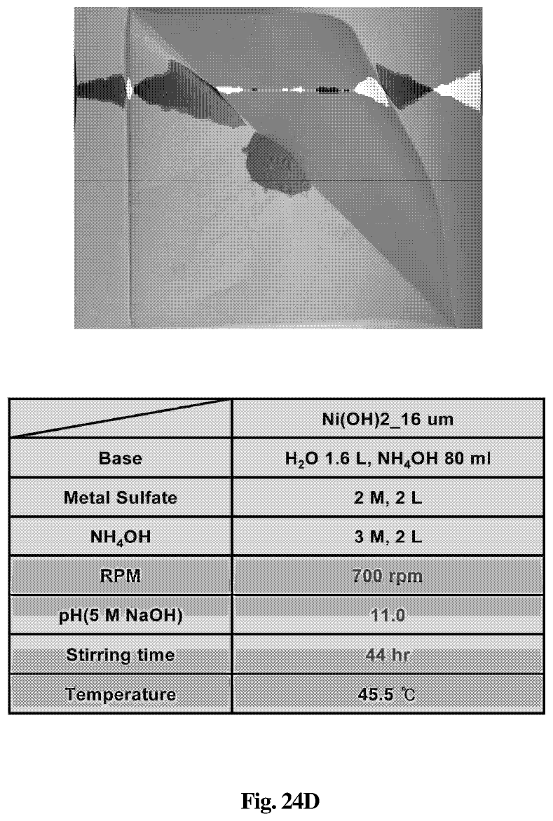

FIG. 24A is a photograph of positive electrode active material precursor particles according to Experimental Example 1 of the present invention; FIG. 24B is a photograph of positive electrode active material precursor particles according to Experimental Example 2 of the present invention; FIG. 24C is a photograph of positive electrode active material precursor particles according to Experimental Example 3 of the present invention; and FIG. 24D is a photograph of positive electrode active material precursor particles according to Experimental Example 4 of the present invention.

Referring to FIGS. 24A to 24D, in the process of preparing the positive electrode active material precursor particles (co-precipitation process), the positive electrode active material precursor particles according to Experimental Examples 1 to 4 having different sizes are prepared by controlling the stirring speed, stirring time, and pH and photographed.

As shown from FIGS. 24A to 24D, in the process of preparing the positive electrode active material precursor particles (co-precipitation process), it can be seen that the size of the prepared positive electrode active material precursor particles increases when the stirring time increases. In addition, it can be seen that the size of the prepared positive electrode active material precursor particles increases when the stirring speed decreases.

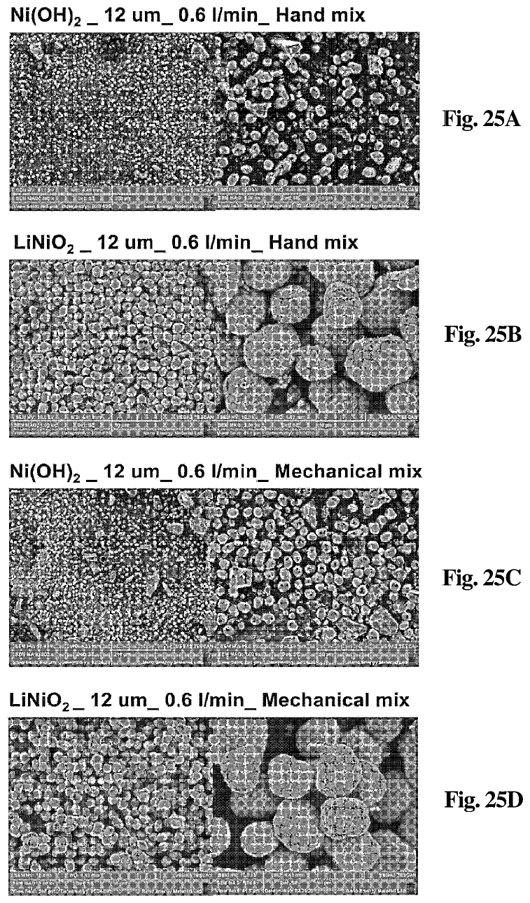

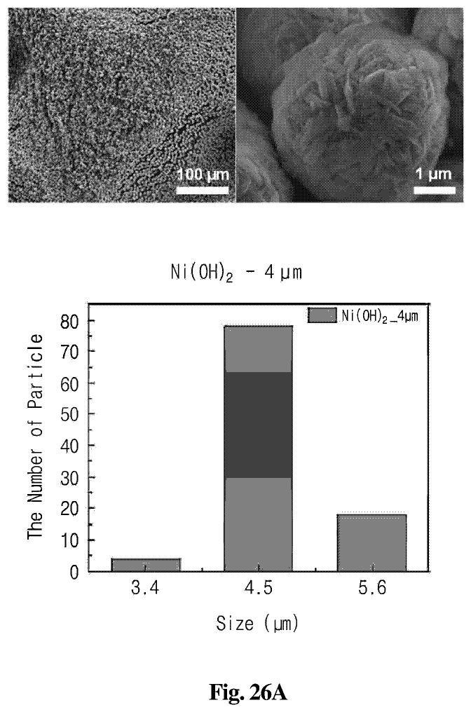

FIG. 25A is an SEM photograph after hand-mixing positive electrode active material precursor particles according to Experimental Example 3 of the present invention; FIG. 25B is an SEM photograph after hand-mixing a lithium source according to Experimental Example 3 of the present invention; FIG. 25C is an SEM photograph after mechanically mixing positive electrode active material precursor particles according to Experimental Example 3 of the present invention; and FIG. 25D is an SEM photograph after mechanically mixing a lithium source according to Experimental Example 3 of the present invention.

Referring to FIG. 25A and FIG. 25B, the positive electrode active material precursor particles according to Experimental Example 3 are hand-mixed using a mortar and a pestle, and the lithium source according to Experimental Example 3 is hand-mixed using a mortar and a pestle and photographed by SEM.

Referring to FIG. 25C and FIG. 25D, the positive electrode active material precursor particles according to Experimental Example 3 are mechanically mixed using Thinky Mixer, and the lithium source according to Experimental Example 3 is mechanically mixed using Thinky Mixer and photographed by SEM.

As shown from FIG. 25A to FIG. 25D, it can be seen that the positive electrode active material precursor and the lithium source are damaged when the positive electrode active material precursor and the lithium source are hand-mixed.

In contrast, it can be seen that the positive electrode active material precursor and the lithium source are not damaged when the positive electrode active material precursor and the lithium source are mechanically mixed.

Therefore, it can be seen that the method of using the mechanical mixing, which is stirring using centrifugal force, in the process of mixing the positive electrode active material precursor and the lithium source is a method for preventing the positive electrode active material precursor and the lithium source from being damaged.

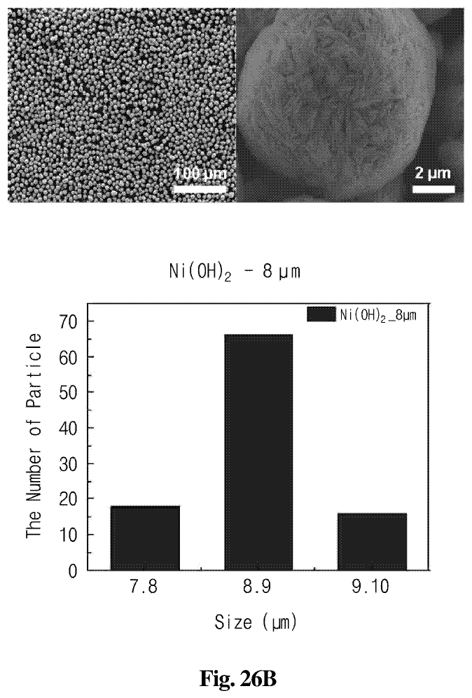

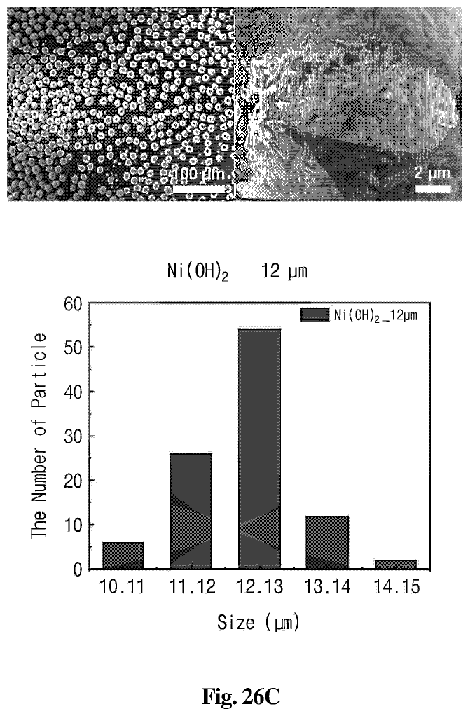

FIG. 26A shows an SEM photograph of positive electrode active material precursor particles according to Experimental Example 1 and a graph showing size distribution of the positive electrode active material precursor particles; FIG. 26B shows an SEM photograph of positive electrode active material precursor particles according to Experimental Example 2 and a graph showing size distribution of the positive electrode active material precursor particles; FIG. 26C shows an SEM photograph of positive electrode active material precursor particles according to Experimental Example 3 and a graph showing size distribution of the positive electrode active material precursor particles; and FIG. 26D shows an SEM photograph of positive electrode active material precursor particles according to Experimental Example 4 and a graph showing size distribution of the positive electrode active material precursor particles.

Referring to FIGS. 26A to 26D, the positive electrode active material precursor particles according to Experimental Examples 1 to 4 are photographed by SEM, and diameters of 100 positive electrode active material precursor particles according to Experimental Examples 1 to 4 are measured using an ImageJ program.

As shown in FIGS. 26A to 26D, it can be seen that the average size of the positive electrode active material precursor particles according to Experimental Example 1 is 4.698 um, and the standard deviation with respect to the size of the positive electrode active material precursor particles is 0.361.

It can be seen that the average size of the positive electrode active material precursor particles according to Experimental Example 2 is 8.419 um, and the standard deviation with respect to the size of the positive electrode active material precursor particles is 0.625 um.

It can be seen that the average size of the positive electrode active material precursor particles according to Experimental Example 3 is 12.249 um, and the standard deviation with respect to the size of the positive electrode active material precursor particles is 0.782.

It can be seen that the average size of the positive electrode active material precursor particles according to Experimental Example 4 is 16.379 um, and the standard deviation with respect to the size of the positive electrode active material precursor particles is 1.041.

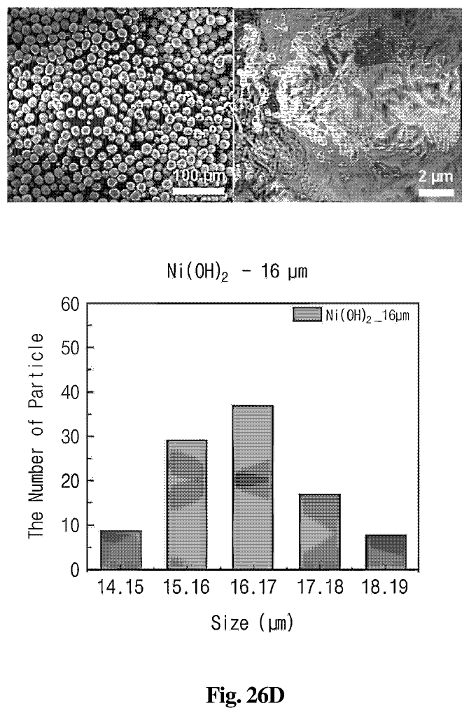

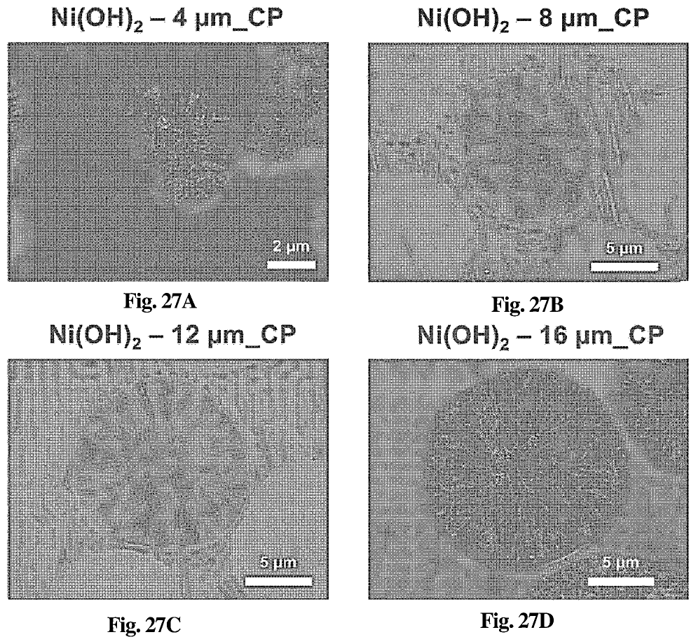

FIG. 27A is a sectional photograph of positive electrode active material precursor particles according to Experimental Example 1 of the present invention; FIG. 27B is a sectional photograph of positive electrode active material precursor particles according to Experimental Example 2 of the present invention; FIG. 27C is a sectional photograph of positive electrode active material precursor particles according to Experimental Example 3 of the present invention; and FIG. 27D is a sectional photograph of positive electrode active material precursor particles according to Experimental Example 4 of the present invention.

Referring to FIG. 27A to FIG. 27D, the positive electrode active material precursor particles according to Experimental Examples 1 to 4 are cross cut and sections thereof are photographed.

As shown in FIG. 27A to FIG. 27D, it can be seen that porosities do not exist in the central portion and the peripheral portion of the positive electrode active material precursor particles according to Experimental Examples 1 to 4.

Accordingly, in the SEM photos of FIGS. 8A to 8D, it can be seen that the density difference between the primary particles in the central portion and the primary particles in the peripheral portion of the positive electrode active material according to Experimental Examples 1 and 2 is caused by the heat-treatment process of the positive electrode active material precursor particles and the lithium source.

Although the present invention has been described in detail using preferred embodiments, the scope of the present invention is not limited to specific embodiments and will be interpreted by the appended claims. In addition, it will be understood by those skilled in the art that many modifications and variations are possible without departing from the scope of the present invention.

### INDUSTRIAL APPLICABILITY

The positive electrode active material according to the embodiments of the present invention may be used in various devices such as a lithium secondary battery, an electric vehicle, a mobile device, and an ESS.

1. A method for preparing a positive electrode active material, the method comprising:
preparing positive electrode active material precursor particles including nickel;
preparing for a lithium source; and
mixing and heat-treating the positive electrode active material precursor particles and the lithium source, thereby preparing a positive electrode active material in which a plurality of primary particles are aggregated, wherein
the heat-treating includes controlling a generation rate of the primary particles of the positive electrode active material by controlling sizes of the positive electrode active material precursor particles.

2. The method of claim 1, wherein the generation rate of the primary particles of the positive electrode active material increases when the sizes of the positive electrode active material precursor particles decrease.

3. The method of claim 2, wherein the primary particles of the positive electrode active material have decreasing uniformity when the sizes of the positive electrode active material precursor particles decrease, and the positive electrode active material has a central portion with decreasing density when the sizes of the positive electrode active material precursor particles decrease.

4. The method of claim 1, wherein the positive electrode active material precursor particle has the size of greater than about 4 um and less than about 16 um.

5. The method of claim 1, wherein the heat-treating of the positive electrode active material precursor particles and the lithium source includes controlling an oxygen partial pressure to be greater than about 0.3 L/min and less than about 1.0 L/min, and controlling the positive electrode active material to have an I₀₀₃/I₁₀₄ ratio greater than about 1.74.

6. The method of claim 1, wherein the heat-treating of the positive electrode active material precursor particles and the lithium source includes mixing the positive electrode active material precursor particles and the lithium source so that a molar ratio of nickel of the positive electrode active material precursor particles and lithium of the lithium source is greater than about 1:1.01 and less than about 1:1.05, and allowing an I₀₀₃/I₁₀₄ ratio of the positive electrode active material to be greater than about 1.74.

7. The method of claim 1, wherein the preparing of the positive electrode active material precursor particles includes:
preparing for a precursor source including nickel, a reducing agent, and a pH adjusting agent; and
providing and co-precipitating the precursor source, the reducing agent and the pH adjusting agent to a reactor to prepare the positive electrode active material precursor particles.

8. The method of claim 7, wherein the preparing of the positive electrode active material precursor particles includes:
controlling the size of the positive electrode active material precursor particle by controlling a stirring speed of mixing the precursor source, the reducing agent and the pH adjusting agent.

9. A method of preparing a positive electrode active material, the method comprising:
preparing positive electrode active material precursor particles including nickel;
preparing for a lithium source; and
mixing and heat-treating the positive electrode active material precursor particles and the lithium source to prepare the positive electrode active material in which a plurality of primary particles are aggregated, wherein
a mixing level of cations of the nickel and cations of lithium in the positive electrode active material is controlled by controlling sizes of the positive electrode active material precursor particles.

10. The method of claim 9, wherein the mixing level of the cations of the nickel and the cations of the lithium in the positive electrode active material increases when the sizes of the positive electrode active material precursor particles decrease.

11. The method of claim 9, wherein the positive electrode active material has a grain size controlled by controlling the sizes of the positive electrode active material precursor particles.

12. The method of claim 11, wherein the grain size of the positive electrode active material increases when the sizes of the positive electrode active material precursor particles decrease.

13. A positive electrode active material including secondary particles in which a plurality of primary particles are aggregated, wherein I₀₀₃/I₁₀₄, which is a ratio between a peak value I₀₀₃ corresponding to a (003) plane to a peak value I₁₀₄ corresponding to a (104) plane, is greater than about 1.74 when an XRD measurement is performed on the positive electrode active material.

14. The positive electrode active material of claim 13, wherein the positive electrode active material has a particle size greater than about 4 um and less than about 16 um.

15. The positive electrode active material of claim 13, wherein the positive electrode active material has a composition of <Formula 1> below.
LiNiO2. <Formula 1>

16. The positive electrode active material of claim 13, wherein the positive electrode active material has a grain size of greater than about 105.0 nm and less than about 158.2 nm.
